(19) United States
(12) Patent Application Publication
(10) Pub. No.: US 2025/0039828 A1
(43) Pub. Date: Jan. 30, 2025

(54) TIME ALIGNMENT CONFIGURATION FOR HYBRID CELLULAR AND UWB POSITIONING

(71) Applicant: QUALCOMM Incorporated, San Diego, CA (US)

(72) Inventors: Alexandros MANOLAKOS, Athens, Attikí (GR); Varun Amar REDDY, San Diego, CA (US); Le Nguyen LUONG, San Diego, CA (US); Krishna Kiran MUKKAVILLI, San Diego, CA (US)

(21) Appl. No.: 18/715,657

(22) PCT Filed: Jan. 27, 2023
(86) PCT No.: PCT/US2023/061481

§ 371 Date: May 31, 2024

(30) Foreign Application Priority Data
Feb. 24, 2022 (GR) 20220100167
Mar. 3, 2022 (GR) 20220100197
Mar. 31, 2022 (GR) 20220100287

(51) Int. Cl. H04W 64/00; H04B 1/7163; H04L 5/00; H04W 8/22

(52) U.S. Cl. CPC H04W 64/00; H04B 1/7163; H04L 5/0051; H04W 8/22

(57) ABSTRACT

In some implementations, a server may send a request to a first wireless device for capability information, wherein the first wireless device is capable of transmitting both cellular and ultra-wideband (UWB) wireless signals. The server may receive a response from the first wireless device, the response comprising the capability information regarding a capability of the first wireless device for performing UWB positioning. The server may determine first UWB assistance data for the first wireless device based at least in part on (i) the capability information and (ii) information regarding one or more positioning signals transmitted in a cellular wireless network, wherein the first UWB assistance data comprises one or more parameters for a first set of one or more UWB positioning sessions between the first wireless device and a second wireless device. The server may send the first UWB assistance data from the server to the first wireless device.

### BACKGROUND

### 1. Field of Disclosure

The present disclosure relates generally to the field of radiofrequency (RF)-based position determination (or positioning) of an electronic wireless device. More specifically, the present disclosure relates to ultra-wideband (UWB)-based positioning.

### 2. Description of Related Art

The positioning of devices can have a wide range of consumer, industrial, commercial, military, and other applications. UWB-based positioning offers a highly-accurate, low-power positioning solution relative to other RF-based positioning techniques for wireless electronic devices.

### BRIEF SUMMARY

An example method for cellular/ultra-wideband (UWB) positioning, according to this disclosure, may comprise sending a request from a server to a first wireless device for capability information, wherein the first wireless device is capable of transmitting both cellular and UWB wireless signals. The method also may comprise receiving, at the server, a response from the first wireless device, the response comprising the capability information, wherein the capability information comprises information regarding a capability of the first wireless device for performing UWB positioning. The method also may comprise determining first UWB assistance data for the first wireless device based at least in part on (i) the capability information and (ii) information regarding one or more positioning signals transmitted in a cellular wireless network, wherein the first UWB assistance data comprises one or more parameters for a first set of one or more UWB positioning sessions between the first wireless device and a second wireless device. The method also may comprise sending the first UWB assistance data from the server to the first wireless device.

An example server for cellular/ultra-wideband (UWB) positioning, according to this disclosure, may comprise a transceiver, a memory, one or more processors communicatively coupled with the transceiver and the memory, wherein the one or more processors are configured to send a request, via the transceiver, from the server to a first wireless device for capability information, wherein: the first wireless device is capable of transmitting both cellular and UWB wireless signals, and the capability information comprises information regarding a capability of the first wireless device for performing UWB positioning. The one or more processors further may be configured to receive, via the transceiver, a response from the first wireless device, the response comprising the capability information. The one or more processors further may be configured to determine first UWB assistance data for the first wireless device based at least in part on (i) the capability information and (ii) information regarding one or more positioning signals transmitted in a cellular wireless network, wherein the first UWB assistance data comprises one or more parameters for a first set of one or more UWB positioning sessions between the first wireless device and a second wireless device. The one or more processors further may be configured to send the first UWB assistance data from the server to the first wireless device via the transceiver.

An example method for cellular/ultra-wideband (UWB) positioning, according to this disclosure, may comprise receiving, at a first wireless device, a request from a server for capability information, wherein the first wireless device is capable of transmitting both cellular and UWB wireless signals. The method also may comprise sending, to the server, a response from the first wireless device, the response comprising the capability information including information regarding a capability of the first wireless device for performing UWB positioning. The method also may comprise receiving, at the first wireless device, first UWB assistance data from the server, wherein the first UWB assistance data comprises one or more parameters for a first set of one or more UWB positioning sessions between the first wireless device and a second wireless device. The method also may comprise conducting, using the first wireless device: the first set of one or more UWB positioning sessions with the second wireless device in accordance with the one or more parameters, and one or more measurements of one or more positioning signals transmitted in a cellular wireless network.

An example first wireless device for cellular/ultra-wideband (UWB) positioning, according to this disclosure, may comprise one or more transceivers capable of transmitting both cellular and UWB wireless signals, a memory, one or more processors communicatively coupled with the one or more transceivers and the memory, wherein the one or more processors are configured to receive, via the one or more transceivers, a request from a server for capability information. The one or more processors further may be configured to send a response via the one or more transceivers to the server, the response comprising the capability information including information regarding a capability of the first wireless device for performing UWB positioning. The one or more processors further may be configured to receive, via the one or more transceivers, first UWB assistance data from the server, wherein the first UWB assistance data comprises one or more parameters for a first set of one or more UWB positioning sessions between the first wireless device and a second wireless device. The one or more processors further may be configured to conduct: the first set of one or more UWB positioning sessions with the second wireless device in accordance with the one or more parameters, and one or more measurements of one or more positioning signals transmitted in a cellular wireless network.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a simplified illustration of a positioning system, according to an embodiment.

FIG. 2A is a diagram illustrating a scenario in which both to ultra-wideband (UWB) and cellular (5G new radio (NR)) wireless technologies may be used for positioning a target device.

FIG. 2B is a simplified diagram illustrating how positioning of a target device may be performed, according to some embodiments.

FIGS. 3A and 3B are flow diagrams illustrating the roles different devices may assume with regard to a UWB ranging session.

FIG. 4 is a flow diagram illustrating how a location server may be used to coordinate hybrid cellular/UWB positioning of a mobile device, according to some embodiments.

FIG. 5 is a timing diagram illustrating an approach to time-domain alignment, according to some embodiments.

FIGS. 6A and 6B are timing diagrams illustrating examples of how a location server may configure a UWB session to optimize hybrid cellular/UWB positioning.

FIGS. 7-10 are timing diagrams illustrating examples of how a location server may configure multiple UWB sessions to optimize hybrid cellular/UWB positioning.

FIG. 11A is a flow diagram of a method configuring a first wireless device for hybrid cellular/UWB positioning, according to an embodiment.

FIG. 11B is a flow diagram of a method using a first wireless device for hybrid cellular/UWB positioning, according to an embodiment.

FIG. 12 is a block diagram of an embodiment of a mobile UWB device, according to an embodiment.

FIG. 13 is a block diagram of an embodiment of a stationary UWB device, according to an embodiment.

FIG. 14 is a block diagram of an embodiment of a computer system, according to an embodiment.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths.

Additionally, unless otherwise specified, references to “reference signals,” “positioning reference signals,” “reference signals for positioning,” and the like may be used to refer to signals used for positioning of a user equipment (UE) in a 5G new radio (NR) network. As described in more detail herein, such signals may comprise any of a variety of signal types but may not necessarily be limited to a Positioning Reference Signal (PRS) as defined in relevant wireless standards.

Further, unless otherwise specified, the term “positioning” as used herein (including, for example, UWB-based positioning, cellular-based positioning, and hybrid cellular/UWB positioning) may include absolute location determination, relative location determination, ranging, or a combination thereof. Such positioning may include and/or be based on timing, angular, phase, or power measurements, or a combination thereof (which may include RF sensing measurements) for the purpose of location or sensing services.

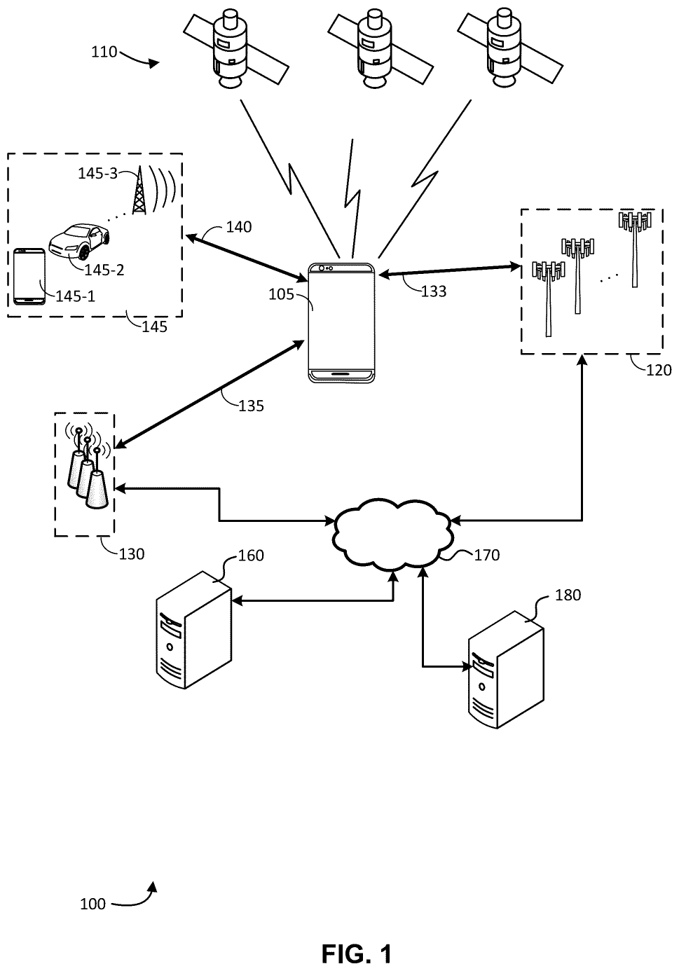

As previously noted, UWB-based positioning offers a highly-accurate, low-power positioning solution relative to other RF-based positioning techniques for wireless electronic devices. UWB-based positioning can be used in industrial applications, such as by robots and/or other Internet of Things (IoT) devices in a factory setting, indoor positioning of consumer electronics, and more. Although UWB-based positioning may be used in an ad hoc manner as a standalone positioning technique between electronic devices capable of UWB positioning (also referred to herein as “UWB devices”), in some embodiments UWB-based positioning may be used as one of many techniques for positioning an electronic device in a positioning system. FIG. 1 provides an example of such a positioning system.

FIG. 1 is a simplified illustration of a positioning system 100 in which a mobile device 105, location server 160, and/or other components of the positioning system 100 can use the techniques provided herein for time alignment configuration for hybrid 5G and UWB positioning of mobile device 105, according to an embodiment. The techniques described herein may be implemented by one or more components of the positioning system 100. The positioning system 100 can include: a mobile device 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the mobile device 105 based on RF signals received by and/or sent from the mobile device 105 and known locations of other components (e.g., GNSS satellites 110, base stations 120, APs 130) transmitting and/or receiving the RF signals. Additional details regarding particular location estimation techniques are discussed hereafter.

It should be noted that FIG. 1 provides only a generalized illustration of various components, any or all of which may be utilized as appropriate, and each of which may be duplicated as necessary. Specifically, although only one mobile device 105 is illustrated, it will be understood that many mobile devices (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include an LTE wireless network, a Fifth Generation (5G) wireless network (also referred to as an NR wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network. In a wireless cellular network (e.g., LTE or 5G), the mobile device 105 may be referred to as a user equipment (UE)

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location server 160, by accessing the network 170 via a base station 120 using a first communication link 133. Additionally or alternatively, because APs 130 also may be communicatively coupled with the network 170, mobile device 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. As used herein, the transmission functionality of a TRP may be performed with a transmission point (TP) and/or the reception functionality of a TRP may be performed by a reception point (RP), which may be physically separate or distinct from a TP. That said, a TRP may comprise both a TP and an RP. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

Satellites 110 may be utilized for positioning of the mobile device 105 in one or more ways. For example, satellites 110 (also referred to as space vehicles (SVs)) may be part of a GNSS such as GPS, GLONASS, Galileo or Beidou. Positioning using RF signals from GNSS satellites may comprise measuring multiple GNSS signals at a GNSS receiver of the mobile device 105 to perform code-based and/or carrier-based positioning, which can be highly accurate. Additionally or alternatively, satellites 110 may be utilized for Non-Terrestrial Network (NTN)-based positioning, in which satellites 110 may functionally operate as TRPs (or TPs) of a network (e.g., LTE and/or NR network) and may be communicatively coupled with network 170. In particular, reference signals (e.g., PRS) transmitted by satellites 110 NTN-based positioning may be similar to those transmitted by base stations 120, and may be coordinated by a location server 160. In some embodiments, satellites 110 used for NTN-based positioning may be different than those used for GNSS-based positioning.

The location server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning system 100 (e.g., GNSS satellites 110, APs 130, base stations 120). The estimated location of the mobile device 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, static communication/positioning device 145-3, or other static and/or mobile device capable of providing wireless signals used for positioning the mobile device 105, or a combination thereof. Wireless signals from mobile devices 145 used for positioning of the mobile device 105 may comprise RF signals using, for example, Bluetooth® (including Bluetooth Low Energy (BLE)), IEEE 802.11x (e.g., Wi-Fi®), UWB, IEEE 802.15x, or a combination thereof. Mobile devices 145 may additionally or alternatively use non-RF wireless signals for positioning of the mobile device 105, such as infrared signals or other optical technologies.

Mobile devices 145 may comprise other mobile devices communicatively coupled with a cellular or other mobile network (e.g., network 170). When one or more other mobile devices 145 are used in the position determination of a particular mobile device 105, the mobile device 105 for which the position is to be determined may be referred to as the “target mobile device,” and each of the other mobile devices 145 used may be referred to as an “anchor mobile device.” (In a cellular/mobile broadband network, the terms “anchor UE” and “target UE” may be used.) For position determination of a target mobile device, the respective positions of the one or more anchor mobile devices may be known and/or jointly determined with the target mobile device. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards. UWB may be one such technology by which the positioning of a target device (e.g., mobile device 105) may be facilitated using measurements from one or more anchor devices (e.g., mobile devices 145).

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond to a component or device on a vehicle, RSU, or other V2X entity that is used to communicate V2X messages. In embodiments in which V2X is used, the static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, east or west and possibly above or below some other known fixed location (including, e.g., the location of a base station 120 or AP 130) or some other location such as a location for mobile device 105 at some known previous time, or a location of a mobile device 145 (e.g., another mobile device) at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium, or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

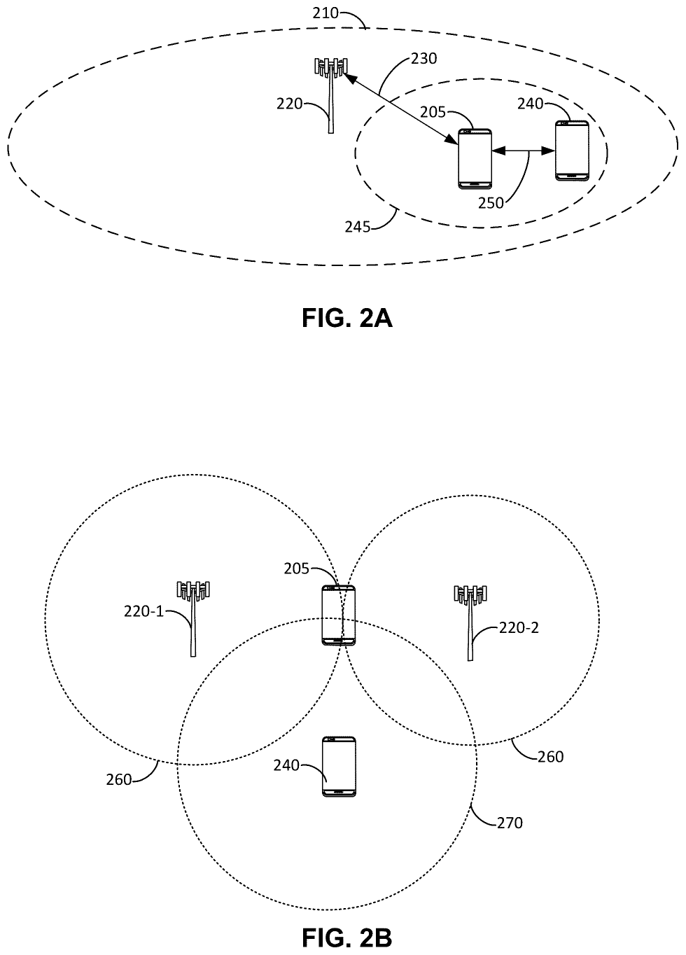

FIG. 2A is a diagram illustrating a scenario in which both UWB and cellular (5G NR) technologies may be used for positioning a target device 205. Here, target device 205 may correspond with mobile device 105 of FIG. 1. Generally put, according to some embodiments, the hybrid cellular/UWB positioning (or simply “cellular/UWB positioning”) of a device may utilize both cellular and UWB positioning technologies to determine the location of a device that is capable of taking positioning-related measurements in both cellular and UWB technologies. The use of both cellular and UWB technologies may utilize additional anchors (cellular and/or UWB anchors) for positioning measurements, which can allow for positioning of a device in situations where the use of a single technology would not, and/or increased accuracy over the use of a single technology. Hybrid cellular/UWB positioning also may be referred to as (hybrid) “5G/UWB” or “NR/UWB” positioning where cellular technology comprises 5G NR.

In this scenario, a target device 205 may comprise a UE of the cellular network within a coverage region 210 of a base station 220, which may comprise a serving base station of the target device 205. Communication between the base station 220 and target device 205 may occur across a network (Uu) interface 230, which may also be used to communicate DL and/or UL reference signals for cellular aspects of hybrid cellular/UWB positioning. According to some embodiments, the positioning of the target device 205 may be coordinated by the network via a location server (not shown), and related configuration data and/or assistance data may be related to the target device 205 by the base station 220 via the network interface 230.

The UWB aspects of hybrid cellular/UWB positioning, the target device 205 may send and/or receive UWB RF signals from UWB device 240, acting as a UWB anchor. The UWB RF signals may be coordinated using an out of band (OOB) interface 250, which may utilize Bluetooth, Wi-Fi, or similar wireless technology, for example, which may have a corresponding wireless coverage region 245. According to some embodiments, the UWB aspects of hybrid cellular/UWB positioning may be coordinated by the target device 205 and/or UWB device 240, or maybe coordinated by location or other server (not shown). In some embodiments, configuration data and/or assistance data may be provided to a target device 205 and/or UWB device 240 directly by the base station 220. In some embodiments, configuration data and/or assistance data may be provided to a target device 205 directly by the base station 220 (e.g., via the network interface 230), and the target device 205 may relay the configuration data and/or assistance data to the UWB device 240 (e.g., via the OOB interface 250.

It can be noted that, although a single base station 220 and a single UWB device 240 are illustrated in FIG. 2, scenarios in which hybrid cellular/UWB positioning of a target device 205 may include one or more base stations and one or more UWB devices.

FIG. 2B is a simplified diagram illustrating how positioning of the target device 205 may be performed, according to some embodiments. Here, measurements using cellular technology may comprise round trip signal propagation delay (RTT) measurements performed between the target device 205 and each of a first base station 220-1 and a second the base station 220-2 to determine a distance between the target device 205 and the base stations 220. (These distances are represented by circles 260.) Additionally, as indicated, measurements and UWB may comprise RTT measurements (also referred to as two-way ranging (TWR) in UWB) performed to determine a distance between the target device 205 and one or more UWB anchors, such as UWB device 240. (The distance between the target device 205 and the UWB device 240 is represented by circles 270.) Using multilateration, the location of the target device 205 may be determined as location in which circles representing the distances (circles 260 and 270) intersect. Because the distances may have some uncertainty, the resulting location of the location of the target device 205 also may have some uncertainty.

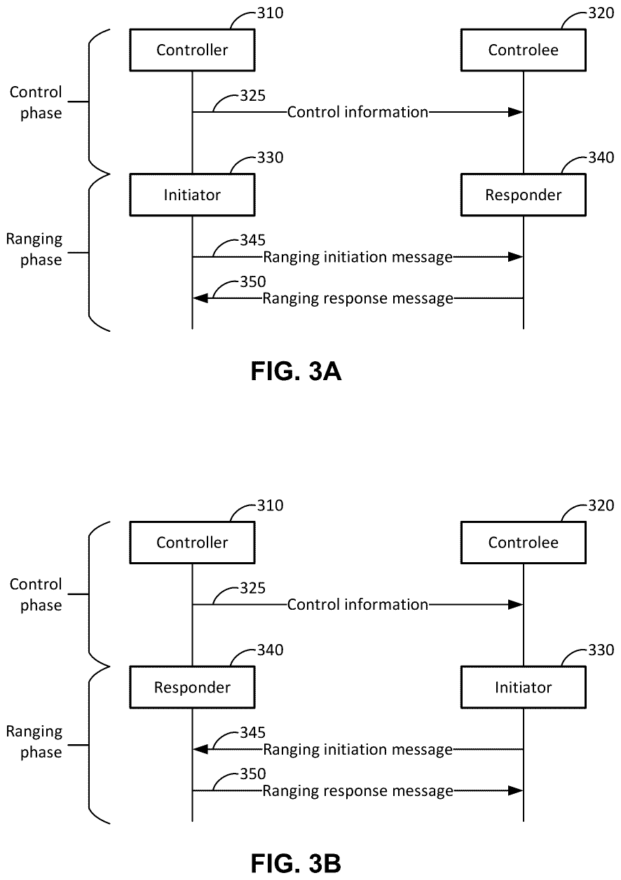

FIG. 3A is a flow diagram illustrating the roles different devices may assume with regard to a UWB ranging session (or simply a “UWB session”). Here, each UWB device may be referred to as an enhanced ranging device (ERDEV). ERDEVs may be referred to different terminologies (e.g. initiator/responder or controller/controlee) at different layers of the network stack. The terms initiator and responder (described hereafter) would be used at lower layers (e.g., at UWB physical (PHY) and media access control (MAC) layers), while the terms controller and controlee (also described hereafter) may be used at higher layers (e.g., an application layer of the ERDEVs). Here, either ERDEV may correspond with a target device 205 or UWB device 240 of FIG. 2, or mobile device 105 of FIG. 1.

As indicated, for a pair of ERDEVs communicating with each other, the controller 310 is an ERDEV that sends control information 325 to a receiving ERDEV, designated as the controlee 320. The control information 325 may include parameters for the UWB ranging session, such as timing, channel, etc. Although not illustrated, the controlee 320 can send acknowledgment to the control information 325, may negotiate changes to the parameters, and/or the like.

The exchange between controller 310 and controlee 320, including the sending of the control information 325 and subsequent related exchanges between controller 310 and controlee 320 regarding control information, may be conducted out of band (OOB) using a different wireless communication technology (e.g., Bluetooth or Wi-Fi), prior to a ranging phase. Put differently, a UWB session may be associated with a control phase and a ranging phase, where the control phase (which may take place on an OOB link) comprises a preliminary exchange between controller 310 and controlee 320 of parameter values for the ranging phase, and the subsequent ranging phase comprises the portion of the UWB session in which devices exchange messages within the UWB band for ranging measurements. (It can be noted, however, that some control information may be exchanged within the UWB band (e.g., a “ranging control phase” occurring in the first slot of a UWB round. Accordingly, some aspects of the control phase may be considered to occur in band, subsequent to the preliminary OOB exchange between the controller 310 and controlee 320.)

The UWB session may occur afterward, in accordance with the parameters provided in the control information. In the ranging phase of the UWB session, one ERDEV may take the role of an initiator 330 and the other ERDEV may take the role of a responder 340. As indicated in FIG. 3A, the initiator 330 may initiate UWB ranging by sending a ranging initiation message 345 to the responder 340, to which the responder 340 may reply with a ranging response message 350, and timing measurements may be made of these messages (by the devices receiving the messages) to perform two-way ranging (TWR). Depending on the parameters of the control information 325, additional exchanges may be made in the ranging phase between the initiator 330 and responder 340 to allow for additional ranging measurements.

The roles of initiator 330 and responder 340 may be indicated in the control information 325. Further, as indicated in FIG. 3A, the controller 310 in the control phase may be the initiator 330 in the ranging phase of the UWB session. Alternatively, as indicated in FIG. 3B, the controller 310 in the control phase may be the responder 340 in the ranging phase. The determination of which device is initiator 330 and which is responder 340 may depend on the parameters set forth in the control information 325, in which case the controlee 320 correspondingly becomes either the responder 340 or the initiator 330. According to some embodiments, a controller/initiator may conduct ranging with multiple controlees/responders.

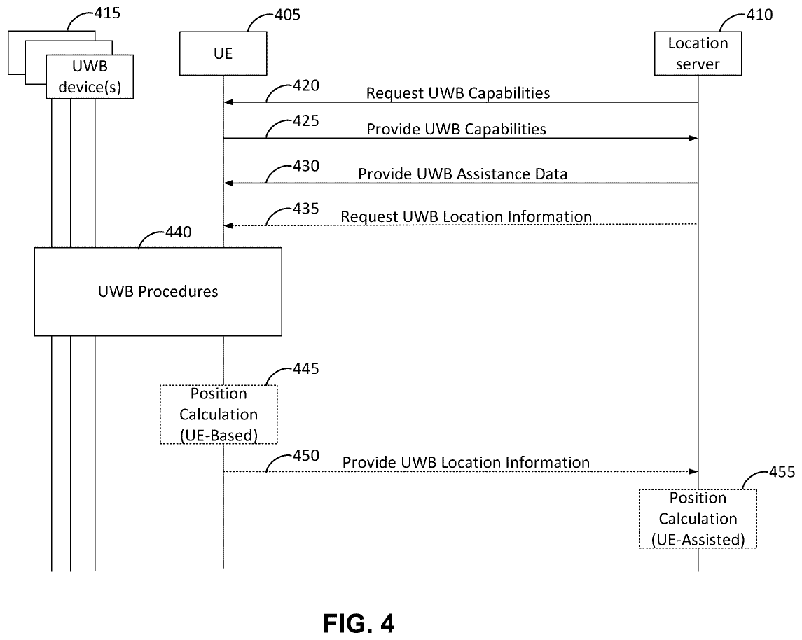

Embodiments herein may help ensure UWB measurements and cellular measurements hybrid cellular/UWB positioning are aligned in the time domain to accurately reflect the position (e.g., at a given time) of a target UE. To do this, embodiments provide for coordination of measurements between cellular reference signals and UWB positioning sessions. FIG. 4 illustrates how this coordination may be performed, according to some embodiments.

FIG. 4 is a flow diagram illustrating how a location server (e.g., an LMF of a 5G network) may be used to coordinate hybrid cellular/UWB positioning of a UE, according to some embodiments. Here, a first UE 405 may communicate with a location server 410 to coordinate a UWB positioning session with one or more UWB devices 415 capable of UWB positioning. In some embodiments, the UWB device(s) 415 may be capable of 5G wireless communications and/or positioning and may therefore be UE(s) in a 5G wireless network. In some embodiments, the UWB device(s) 415 may not be capable of 5G wireless communications and/or positioning. Communications between the location server 410 and first UE 405 may be made via a relevant communication protocol of a 5G wireless network, such as LTE positioning protocol (LPP). The first UE 405 may comprise a target UE for which a position determination is desired.

As illustrated, the process may begin with exchange of the first UE UWB capabilities. This exchange may comprise the location server 410 requesting UWB capabilities, as illustrated at arrow 420, to which the first UE 405 may respond by providing its UWB capabilities, as illustrated at arrow 425. According to some embodiments, the first UE 405 (acting as a controlee) can inform the location server 410 (acting as a controller) of information for negotiating UWB configuration parameters. This information can comprise traditional UWB configuration parameters, as provided in relevant UWB standards. Additionally or alternatively, parameters can include quality of service (QOS)-related parameters, such as the choice of the pulse shape, the accuracy desired (either by Tx or Rx), the type of positioning algorithm that will be employed (which would enable the location server to gauge the latency involved), or any combination thereof.

Based on these UWB capabilities, the location server 410 may then provide UWB assistance data, as indicated at arrow 430. The UWB assistance data also may be based on prior knowledge of the location of the first UE 405 and the existence of UWB device(s) 415 in the vicinity having UWB capabilities.

The assistance data may comprise relevant parameters for performing a UWB session between the UE 405 and the UWB device(s) 415. This may include a ranging method (e.g., one-way ranging (OWR), single-sided TWR (SS-TWR), double-sided TWR (DS-TWR)), a number of controlees, a multi-node mode (e.g., one-to-one or one-to-many), supported ranging message formats (SP0-SP3), time of flight (ToF) and/or angle of arrival (AoA) report, clock draft (which may include a numerical value, range, or threshold, such as whether the clock drift is within 25 ppm), scrambled timestamp sequence (STS) configuration (e.g., static or dynamic), a maximum number of retries allowed, block striding (e.g., whether UWB blocks can be skipped), session initiation time until first UWB packet is sent, block/round/slot duration, PRF mode (e.g., B PRF or H PRF), channel number, key rotation, or CAP size range (e.g., minimum and maximum range values of the CAP size), or a combination thereof. Additionally or alternatively, the assistance data can indicate, for each UWB session conducted between the first UE 405 and the UWB device(s) 415, which UE is to be the initiator and which UE is to be the responder.

The exchange shown by arrows 420 and 425 may be similar to an OOB exchange conducted by a controller and controlee in a control phase of a UWB session (e.g., as illustrated in FIGS. 3A and 3B). Here, the OOB technology used comprises a 5G communication link (e.g., using LPP messages), the location server 410 comprises the controller, and the first UE 405 comprises the controlee. The UWB assistance data (provided at arrow 430) may comprise control information for the UWB session.

Optionally (as indicated by the dotted arrow 435), the location server 410 may request UWB location information from the first UE 405. The requested UWB location information may comprise UWB measurements performed by the first UE 405 and/or the UWB device(s) 415. According to some embodiments, the request may include new parameters to optimize the UWB and 5G measurements. This action may be taken by the location server 410 for UE-assisted positioning in which the location server 410 determines the position of the first UE 405 and/or a position of the first UE 405 is desired by the network (e.g., an positioning function within the mobile/cellular network, or a responsive to a positioning request made by an external client). Alternatively, (e.g., for UE-based positioning) the location server 410 may not request the UWB location information.

At block 440, the first UE 405 and UWB device(s) 415 engage in one or more UWB sessions to perform UWB measurements. The UWB session(s) may be conducted in accordance with the parameters provided by the location server 410 in the assistance data.

The remaining actions in the process illustrated in FIG. 4 may be dependent on whether the position is determined by the first UE 405 (e.g., UE-based positioning) or whether the position is determined by the location server 410 (e.g., UE-assisted positioning. For UE-based positioning, UE may perform positioning calculation, as indicated at block 445. Alternatively, for UE-assisted positioning (e.g., in which the location server 410 sends a request for UWB location information, as indicated at arrow 435), the UE can provide the requested UWB location information to the location server, as indicated at arrow 450. Once it receives the UWB location information the location server 410 may calculate the position of the first UE 405, as indicated at block 455. To enable position determination, the UWB location information may include measurement information of UWB measurements performed during the UWB procedures of block 440. This information may comprise measurements, UE-UWB-IDs, and timestamps. It may also include location information of the UWB device(s) 415, if known. This location information may be provided by the UWB device(s) 415 to the first UE 405, during the UWB procedures of block 440. For UE-assisted mode, the location information may comprise position estimate of the UE that is calculated by the UE

Because the location server can be used to centrally coordinate UWB measurements and cellular measurements for hybrid cellular/UWB positioning, it can implement optimizations to help ensure accurate positioning. As noted, this may include ensuring that cellular measurements and UWB measurements are aligned in the time domain (e.g., occur within a threshold amount of time from one another). This can help minimize changes in a wireless channel when cellular and UWB measurements are performed. Other optimizations may include ensuring that you double you be sessions occurring during the same time occur using different frequencies or channels.

A location server may include, in the assistance data (or any other data configuring the UWB and/or cellular positioning sessions in which UWB and cellular measurements are taken), configuration information to help implement such optimizations. This optimized configuration information may include, for example, a measurement time window in which both UWB and cellular measurements are to take place. Upon receiving this configuration information, the UE is expected to perform measurements in UWB and cellular within the suggest measurement time window. This can enable time aligned to avoid errors due to UE mobility. This can also drive the start and duration of the UWB ranging session. Optimized configuration information may further include information regarding a channel frequency to use for UWB and/or adjusting cellular frequency (e.g., 5G Band PRS) based on the knowledge of the used UWB band. This can be done to help minimize any interference between cellular signal(s) (e.g., PRS) and UWB occurring in overlapping frequency bands and/or to increase diversity.

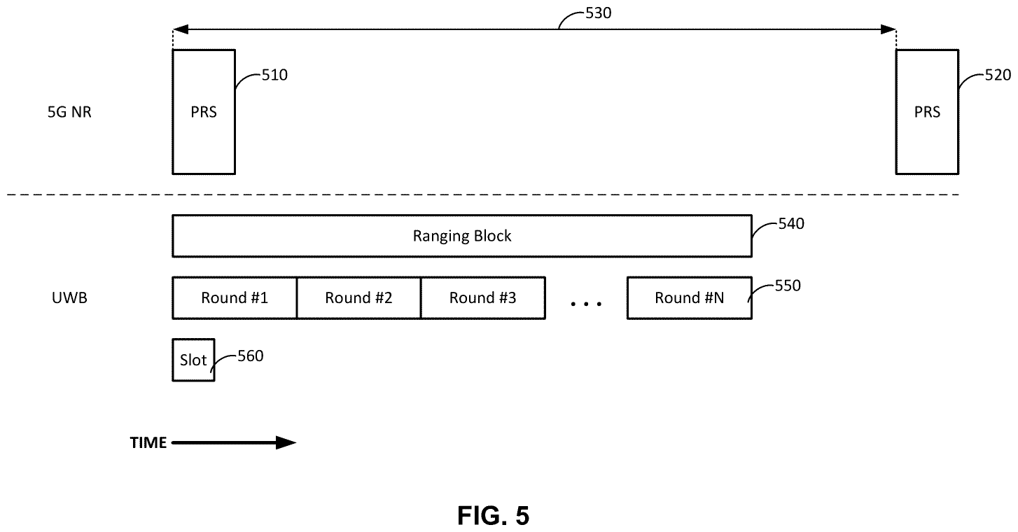

FIG. 5 is a timing diagram illustrating an approach to time-domain alignment, according to some embodiments. This illustration shows relative timing for cellular (5G) measurements (using measurements of 5G PRS) and UWB measurements.

PRS may be used for positioning in an NR (and/or other cellular) wireless network, and may be transmitted by wireless network nodes, such as base stations (e.g., TRPs) and network-connected UEs communicatively coupled with the NR wireless network. Depending on the type of positioning performed, PRS may be used for positioning measurements such as time difference of arrival (TDOA), angle of departure (AoD), round trip signal propagation delay (RTT), or a combination thereof. A “PRS instance” or “PRS occasion” is one instance of a periodically repeated time window (e.g., a group of one or more consecutive slots in a Orthogonal Frequency Division Multiplexing (OFDM) used in the NR wireless network) where PRS are expected to be transmitted. A PRS occasion may also be referred to as a “PRS positioning occasion,” a “PRS positioning instance, a “positioning occasion,” “a positioning instance,” or simply an “occasion” or “instance.” Because PRS may be broadcast, the first PRS 510 and second PRS 520 may be received by either or both initiator and responder devices in a UWB positioning session (e.g., depending on their capabilities). The first PRS 510 and second PRS 520 may comprise two instances of a PRS sequence (which may include more instances) that is transmitted at a periodicity 530. The default value of periodicity 530 for PRS is 160 ms, but this is configurable (e.g., by the location server) and may change, depending on desired functionality.

The timing in a UWB session may occur over a period of time divided into sub-portions according to a hierarchical structure. Similar to a TDMA scheme, the UWB session defines timing during which ranging can occur. This timing comprises consecutive one or more consecutive ranging blocks 540, which may have a configurable duration (e.g., 200 ms). Each ranging block 540 may be split into one or more successive rounds 550 (e.g., N rounds), the number and length of which are configurable. The rounds 550 are further split into different slots 560, which also have a configurable number and length. According to some embodiments, a single round in each ranging block 540 may be used for UWB positioning, to help reduce RF collisions.

Because the location server is aware of the parameters of the first and second PRS 510, 520 (e.g., periodicity 530, duration (e.g., 4 ms), frequency, etc.) it can help ensure the UWB ranging block 540 of a UWB positioning session for hybrid NR/UWB positioning aligns with the first and second PRS 510, 520 in an optimal fashion by providing assistance data to configure the UWB devices to help ensure this alignment. In particular, the location server (acting as controller) can provide assistance data to a controlee UE (e.g., first UE 405 of FIG. 4), based on the capabilities of the controlee UE, that configures the controlee UE to specify the start the ranging block 540, which round 550 to use within the ranging block for UWB positioning, which number of slots are to be used within a ranging round, or a combination thereof.

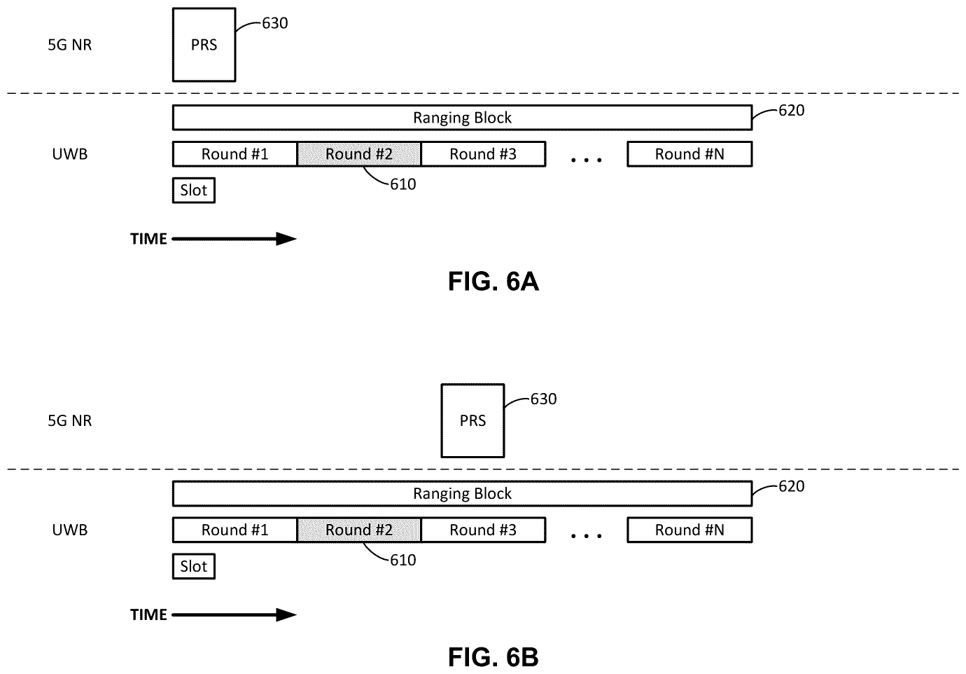

FIG. 6A illustrates an example of how a location server may configure a UWB session to optimize hybrid NR/UWB positioning. Here, the location server provides assistance data to configure a controlee UE to use a selected round 610 of a ranging block 620 to use for UWB positioning. The selected round 610 may be identified in the assistance data using its corresponding round index (e.g., Round #2). To help ensure time-domain alignment with NR positioning, a round may be selected for UWB positioning based on how close in time it is to a PRS. In FIG. 6A, the selected round 610 is the round in the ranging block 620 that is closest in time to the PRS 630 without overlapping with the PRS 630 in time (thereby avoiding potential interference). In general a round may be selected based on whether it occurs within a threshold amount of time from a PRS. This threshold of time may be based on a QoS capability of the controlee UE, mobility of the controlee UE, QoS requirement of a positioning session, or other such factors, or a combination thereof. The selected round 610 may occur subsequent to the closest PRS 630 as shown in FIG. 6A, or may occur prior to the closest PRS 630, as indicated in FIG. 6B.

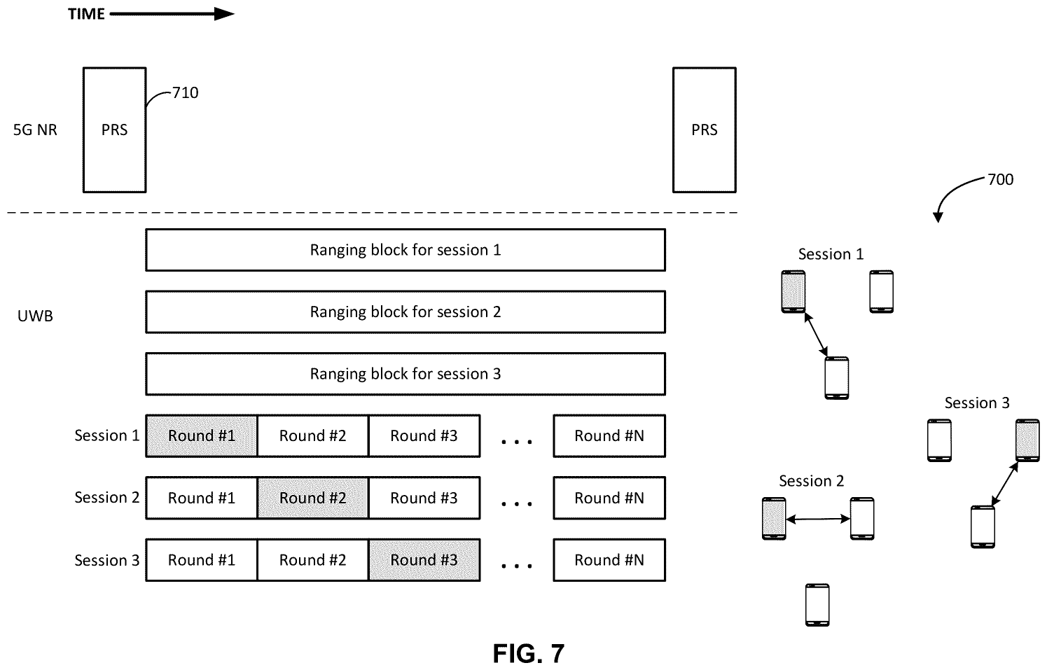

FIG. 7 is a diagram illustrating an example of coordination of NR and UWB positioning sessions for hybrid NR/UWB positioning in which three UWB positioning sessions take place between three devices capable of both NR and UWB positioning (herein “NR/UWB devices”). UWB sessions occur between different pairs of NR/UWB devices for each of session 1, session 2, and session 3, as indicated in the configurations 700. (In the configurations 700, the shaded NR/UWB device may comprise the initiator for the UWB session. In this example, the same NR/UWB device is the initiator for both session 1 and session 2.)

In this example, PRS 710 may be broadcast (e.g., by a base station or other wireless network node of a 5G network) and received by all three NR/UWB devices. To avoid interference between the PRS 710 and UWB ranging sessions, a location server may configure the NR/UWB devices such that UWB sessions occur subsequent to the PRS 710, as illustrated. In this example, ranging blocks for each of session 1, session 2, and session 3 begin at the same time, although sessions may occur at different times in alternative embodiments. To avoid RF collisions, the different sessions use different rounds for UWB positioning. (As indicated by the shading, session 1 uses round #1 session 2 uses round #2 and session 3 uses round #3.) 5G NR positioning may utilize multiple PRS, and UWB ranging sessions may utilize multiple ranging blocks (which may use the same respective rounds as illustrated in FIG. 7).

FIG. 7 illustrates just one example configuration. The temporal alignment between different UWB sessions and/or between the UWB sessions and PRS may vary, depending on desired functionality. Additional examples are provided in the following figures.

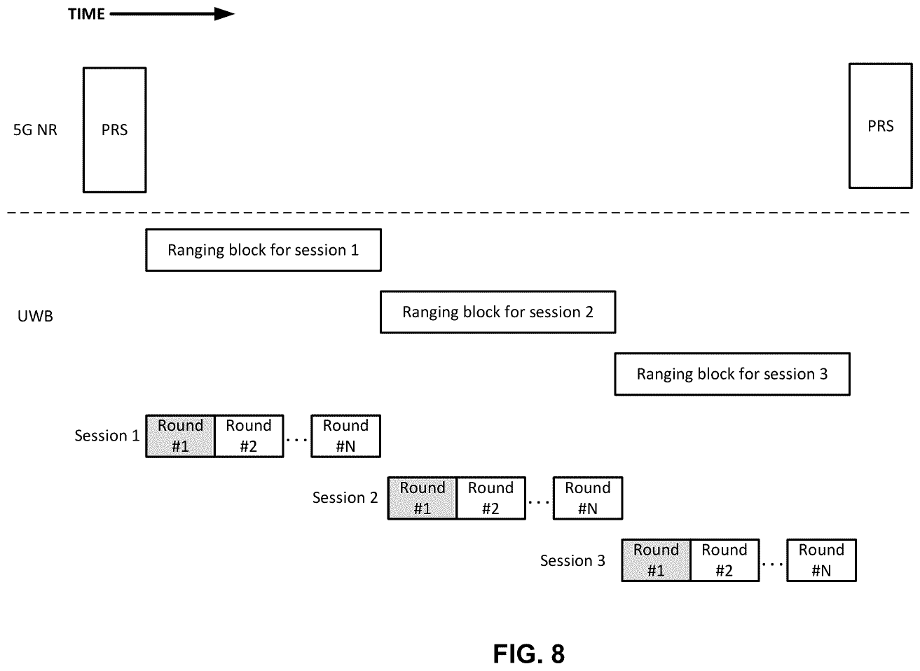

FIG. 8 is a diagram illustrating another example of coordination of NR and UWB positioning sessions for hybrid NR/UWB positioning. Here again, three UWB positioning sessions take place (e.g., between three NR/UWB devices). In this example, however, ranging blocks are offset in time from one another, and the same round (round #1) is selected in each ranging block for UWB positioning. Although this example does not show any overlap between ranging blocks of different sessions, alternative embodiments may have overlap. Additionally or alternatively, different sessions may use different respective rounds for UWB positioning (e.g., rather than using the same respective round). A location server may configure NR/UWB devices with non-overlapping ranging blocks (e.g., rather than overlapping ranging blocks, as shown in FIG. 7) to accommodate NR/UWB device capabilities, where a NR/UWB device may be incapable of participating in multiple UWB positioning sessions at once.

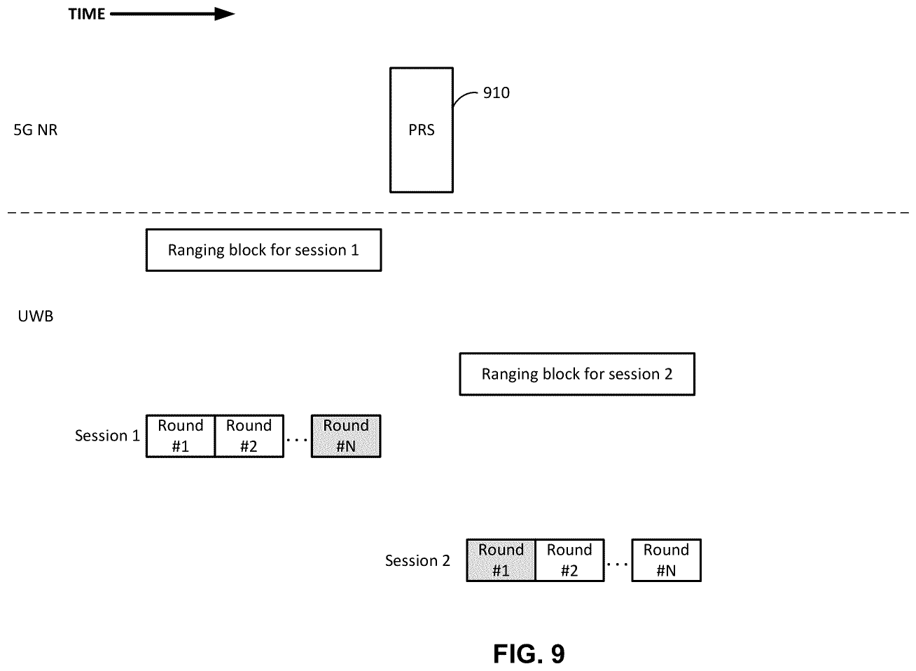

FIG. 9 is a diagram illustrating another example of coordination of NR and UWB positioning sessions for hybrid NR/UWB positioning. In this example, UWB sessions (session 1 and session 2) take place, where a ranging block for session 1 is configured to occur before PRS 910, and ranging block for session 2 is configured to occur after PRS 910. As can be seen, this can allow for UWB positioning to be more aligned with PRS 910 then if ranging blocks both occurred subsequent (or prior to) to the PRS 910. Further, as indicated, rounds within the ranging blocks may be selected to align the UWB positioning even more with the PRS 910. That said, alternative embodiments may use different rounds than illustrated.

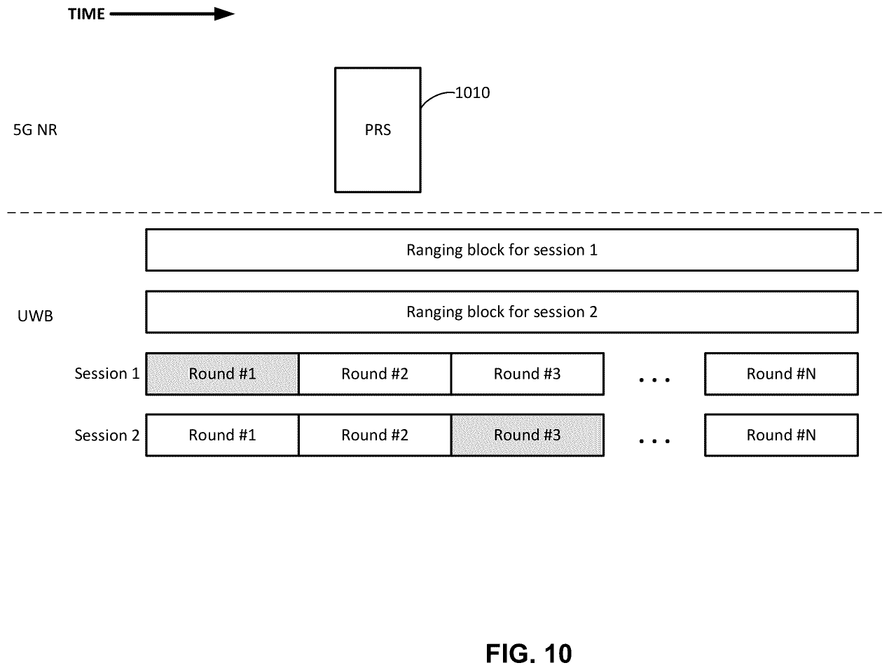

FIG. 10 is a diagram illustrating yet another example of coordination of NR and UWB positioning sessions for hybrid NR/UWB positioning. This example combines simultaneous (or overlapping) ranging blocks of different sessions (as illustrated in FIG. 7) with selecting rounds aligned closely and time to the PRS 1010 (as illustrated in FIG. 9). In this case, rounds in ranging blocks of different sessions are selected to be close to the PRS 1010. However, to avoid interference with the PRS 1010, the (round #2) in the ranging blocks that overlap with the PRS 1010 is not selected for UWB positioning.

As a person of ordinary skill in the art will appreciate, different combinations of the principles illustrated in FIGS. 7-10 may be applied in different hybrid NR/UWB positioning configurations, depending on desired functionality. That is, the ranging blocks and the selected rounds for UWB positioning aligned with PRS in any of a variety of ways to optimize time alignment and help reduce interference. Further, depending on device capability, a location server may configure multiple UWB positioning sessions in parallel using different channels. For example, two pairs of devices may perform UWB positioning at the same time (even using the same or overlapping rounds) without interference on different channels, if different devices are used. (A single device may not be capable of operating on two channels at the same time, given hardware limitations.) For devices engaged in multiple positioning sessions on different channels/frequencies simultaneously, a location server may account for time it may take to re-tune RF components from one frequency/channel to another when determining hybrid NR/UWB positioning configurations. Further, alternative embodiments may use forms of hybrid cellular/UWB positioning that include additional and/or alternative cellular technologies (e.g., in addition or as an alternative to 5G NR).

As previously noted, UWB sessions may comprise a plurality of ranging blocks, which may occur in succession over a period of time. For a given UWB session, UWB measurements take place in the same round of each ranging block (e.g., the same round index will be used for each ranging block), unless a new round index is specified (e.g., in new assistance data) or hopping is selected (in which case different rounds are used for different ranging blocks). In some implementations, the periodicity between PRS (e.g., periodicity 530 of FIG. 5) may not be a multiple of the length of a ranging block. As such, a given round in a first ranging block that does not overlap (and potentially collide) with a PRS may collide in a subsequent ranging block/PRS. As such, a hopping mode for round use in UWB positioning (also referred to herein as “UWB round hopping”) may be used, in which different rounds (e.g., rounds with different round indexes) are used in successive ranging blocks of a UWB session.

According to relevant UWB standards, UWB round hopping utilizes a random sequence generator using the Advanced Encryption Standard (AES) that generates randomized round indices for all rounds within a given block. The sequence generator uses the session ID of a UWB session, which can help ensure a secure pattern is generated. The use of a random sequence generator can help reduce collisions. However, because hopping is random, random collisions may still occur.

Although some embodiments may utilize such random hopping, some embodiments may utilize a specified hopping pattern, which may be determined by a location server and provided to cellular/UWB devices via assistance data. That is, because a location server may know PRS transmission timing, it can determine (e.g., prior to UWB positioning in a hybrid cellular/UWB positioning session) whether a collision may occur between a PRS transmission and a round used for UWB positioning if, for example, a static round index is used for the UWB positioning session. To help avoid the collision (and avoid any possible collision that could occur if random hopping is utilized), the location server can determine a hopping pattern that avoids collision with PRS transmission (and other UWB things sessions the location server may be aware of) and include the hopping pattern in the assistance data to the cellular/UWB device(s) of the affected UWB positioning session(s). According to some embodiments, this predetermined hopping pattern may be multi-casted by the location server to multiple cellular/UWB devices (e.g., over a secure link, as part of UWB assistance data), which may be relayed wirelessly to the multiple cellular/UWB devices, for example, via one or more base stations of the cellular network.

Although embodiments described herein indicate providing UWB assistance data for each UWB positioning session, embodiments are not so limited. Embodiments may include, for example providing UWB assistance data applicable to two or more UWB positioning sessions (e.g., positioning sessions occurring in succession). As such, according to some embodiments, parameters and/or other information provided to a UWB device for use in a UWB positioning session may apply to a set of one or more UWB positioning sessions.

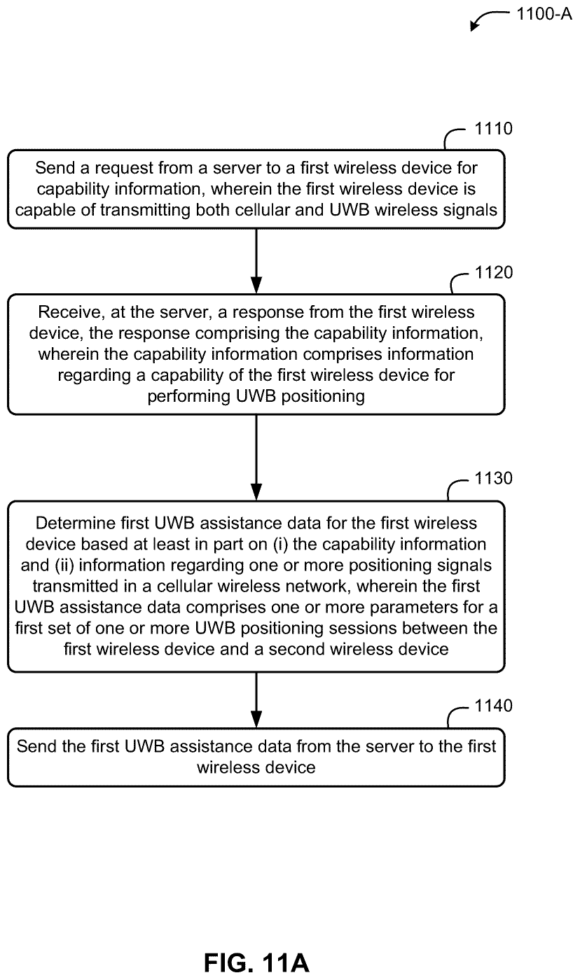

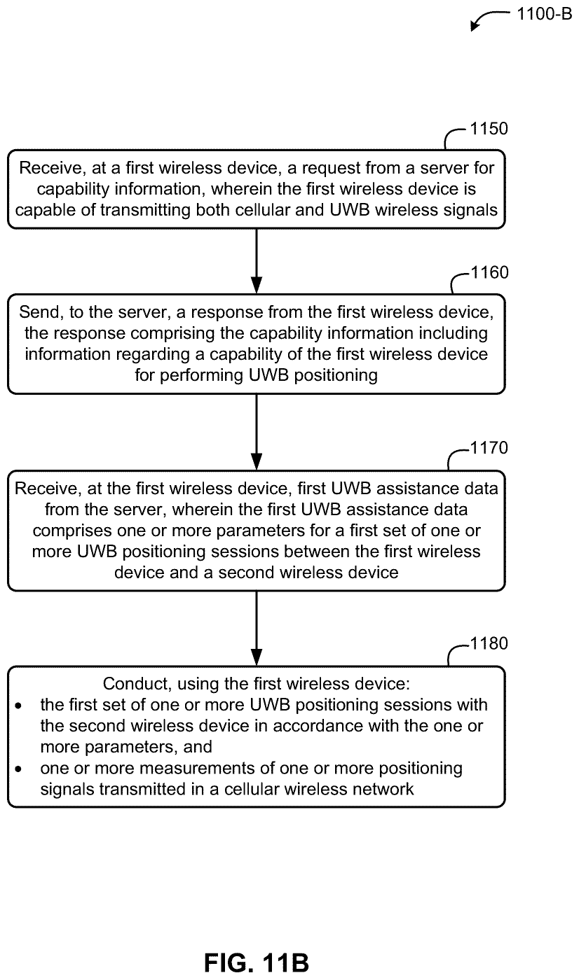

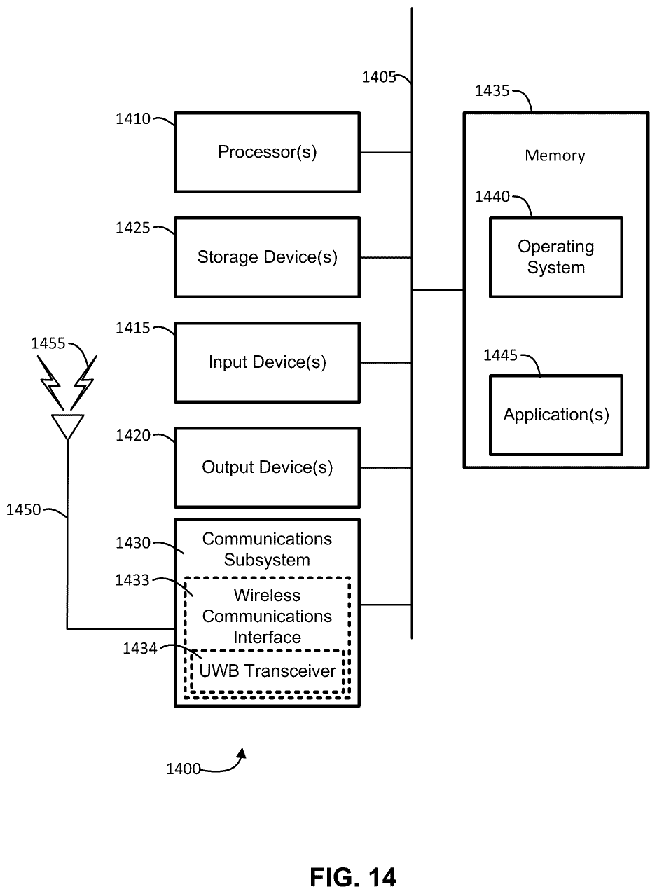

FIG. 11A is a flow diagram of a method 1100-A for cellular/UWB positioning, according to an embodiment. Means for performing the functionality illustrated in one or more of the blocks shown in FIG. 11A may be performed by hardware and/or software components of a server (e.g., a computer server). Example components of a computer system that may comprise a server are illustrated in FIG. 14 which is described in more detail below.

At block 1110, the functionality comprises sending a request from a server to a first wireless device for capability information, wherein the first wireless device is capable of transmitting both cellular and UWB wireless signals, and the capability information comprises information regarding a capability of the first wireless device for performing UWB positioning. According to some embodiments, the exchange between the server and the first wireless device may be similar to an exchange between a controller and controlee in a control phase of a UWB positioning session. As such, the server may be acting as the controller, and the first wireless device may be acting as the controlee. Communications between the server and first wireless device may be relayed by one or more additional devices (e.g., a base station of a cellular wireless network, such as an LTE or NR network, for example). Means for performing functionality at block 1110 may comprise a bus 1405, processor(s) 1410, memory 1435, communications subsystem 1430 (e.g., including optional wireless communication interface 1433 and/or optional UWB transceiver 1434), and/or other components of a computer system 1400, as illustrated in FIG. 14 and described hereafter.

The functionality at block 1120 comprises receiving, at the server, a response from the first wireless device, the response comprising the capability information. The capability information (comprising information regarding a capability of the first wireless device for performing UWB positioning) may include capability information including channel capability, measurement capability (types of measurements, precision/accuracy, etc.), timing capability (e.g., availability for UWB positioning), message format capability, and/or the like. As also noted, a device may also provide QoS-related parameters for s UWB positioning session. As such, according to some embodiments of the method 1100-A, the response received at block 1120 may further comprise QoS parameters comprising information indicative of a pulse shape, a desired accuracy, or a type of positioning algorithm for the first set of one or more UWB positioning sessions, or a combination thereof. Means for performing functionality at block 1120 may comprise a bus 1405, processor(s) 1410, memory 1435, communications subsystem 1430 (e.g., including optional wireless communication interface 1433 and/or optional UWB transceiver 1434), and/or other components of a computer system 1400, as illustrated in FIG. 14 and described hereafter.

The functionality at block 1130 comprises determining first UWB assistance data for the first wireless device based at least in part on (i) the capability information and (ii) information regarding one or more positioning signals transmitted in an cellular wireless network, wherein the first UWB assistance data comprises one or more parameters for a first set of one or more UWB positioning sessions between the first wireless device and a second wireless device. As noted, the server may comprise a location server (e.g., LMF server) that may have knowledge of where PRS will be transmitted in the cellular wireless system and used by one or more devices participating in the first set of one or more UWB positioning sessions. As such, the server may determine first UWB assistance data that aligns the UWB positioning measurements in time with PRS (e.g., in the manner indicated in the previously-described embodiments). The one or more parameters of the first set of one or more UWB positioning sessions may include a configuration that conveys this time-domain alignment. According to some embodiments, the one or more parameters for the first set of one or more UWB positioning sessions comprise a start time for a ranging block, a round of a ranging block to use, a number of slots to use within a round of a ranging block, or a frequency channel to use, or a combination thereof. Additionally or alternatively, as previously described, a server may determine a hopping pattern or use in the set of one or more UWB positioning sessions to avoid interference with PRS. As such, some embodiments of the method 1100-A may further comprise determining a hopping pattern for round usage in the first set of one or more UWB positioning sessions based on the information regarding one or more positioning signals transmitted in a cellular wireless network, wherein the one or more parameters for the first set of one or more UWB positioning sessions comprise the determined hopping pattern. Means for performing functionality at block 1130 may comprise a bus 1405, processor(s) 1410, memory 1435, communications subsystem 1430, and/or other components of a computer system 1400, as illustrated in FIG. 14 and described hereafter.

At block 1140, the method 1100-A comprises sending the first UWB assistance data from the server to the first wireless device. As noted, according to some embodiments, the cellular wireless network comprises an NR wireless network and the server may comprise an LMF of the cellular wireless network. In such embodiments, the request, the response, or the first UWB assistance data, or a combination thereof, may be communicated via LPP. Additionally or alternatively, the one or more positioning signals may comprise one or more positioning reference signal PRS instances. That said, other types of signals used for positioning may be used, such as a tracking reference signal (TRS), Channel-State Information Reference Signal (CSI-RS), or others.

Means for performing functionality at block 1140 may comprise a bus 1405, processor(s) 1410, memory 1435, communications subsystem 1430 (e.g., including optional wireless communication interface 1433 and/or optional UWB transceiver 1434), and/or other components of a computer system 1400, as illustrated in FIG. 14 and described hereafter. [we should have another flow diagram that captures the operations/functions from the UE's point of view (e.g., receiving a request from location server for capability information, providing capability information to the server, receiving assistance data from the server that comprises UWB ranging configuration information, performing UWB ranging based on the configuration information, etc.]

As noted in the previously-described embodiments, configuring a first wireless device for cellular/UWB positioning may implement one or more additional features, depending on desired functionality. As illustrated in FIGS. 6A and 6B, a round of a UWB ranging block nearest to the PRS may be selected to help ensure time alignment. Thus, according to some embodiments of the method 1100-A, one or more parameters for the first set of one or more UWB positioning sessions may specify using a round selected from of a plurality of rounds of a ranging block. For a particular positioning signal of the one or more positioning signals, the selected round may be closest in time, of the plurality of rounds, to the particular positioning signal, and the selected round may not overlap in time with the particular positioning signal.

As noted in FIGS. 7-10, a location server may configure multiple UWB sessions to be optimally time-aligned with PRS, according to some embodiments. Thus, some embodiments of the method 1100-A may further comprise sending second UWB assistance data comprising one or more parameters for a second set of one or more UWB positioning sessions. Here, the second UWB assistance data may be sent from the server to the first wireless device, the second wireless device, or a third wireless device, or a combination thereof. In such embodiments, the one or more parameters for the first set of one or more UWB positioning sessions may specify using a first round of a first ranging block having a first round index, the one or more parameters for the second set of one or more UWB positioning sessions specify using a second round of a second ranging block having a second round index different than the first round index, and the first ranging block and the second ranging block overlap in time.

As shown in FIGS. 7 and 10, overlapping ranging blocks may use different rounds to optimize time alignment with PRS. Thus, according to some embodiments of the method 1100-A, for a particular positioning signal closest in time, of the one or more positioning signals, to the first round: the first round maker subsequent to the particular positioning signal; and the second round may occur subsequent to the first round. According to some embodiments, for a particular positioning signal closest in time, of the one or more positioning signals, to the first round: the first ranging block and the second ranging block may overlap in time with the particular positioning signal, the first round may occur prior to the particular positioning signal, and the second round may occur subsequent to the particular positioning signal.

As shown in FIGS. 8 and 9, separate ranging blocks may be used for time alignment. According to some embodiments of the method 1100-A, the one or more parameters for the first set of one or more UWB positioning sessions make specify using a first round of a first ranging block having a first round index, the one or more parameters for the second set of one or more UWB positioning sessions specify using a second round of a second ranging block having a second round index, and the first ranging block and the second ranging block do not overlap in time. In such embodiments, for a particular positioning signal closest in time, of the one or more positioning signals, to the first ranging block: the first ranging block may occur subsequent to the particular positioning signal, the second ranging block may occur subsequent to the first round, and the second round index may be the same as the first round index. According to some embodiments, for a particular positioning signal closest in time, of the one or more positioning signals, to the first ranging block the first ranging block may occur prior to the particular positioning signal, and the second ranging block may occur subsequent to the particular positioning signal.

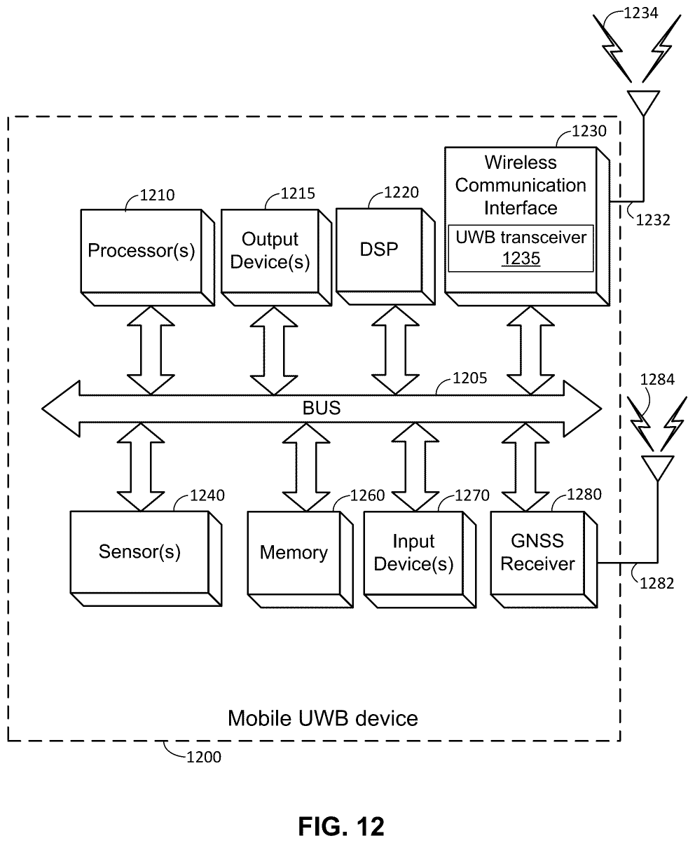

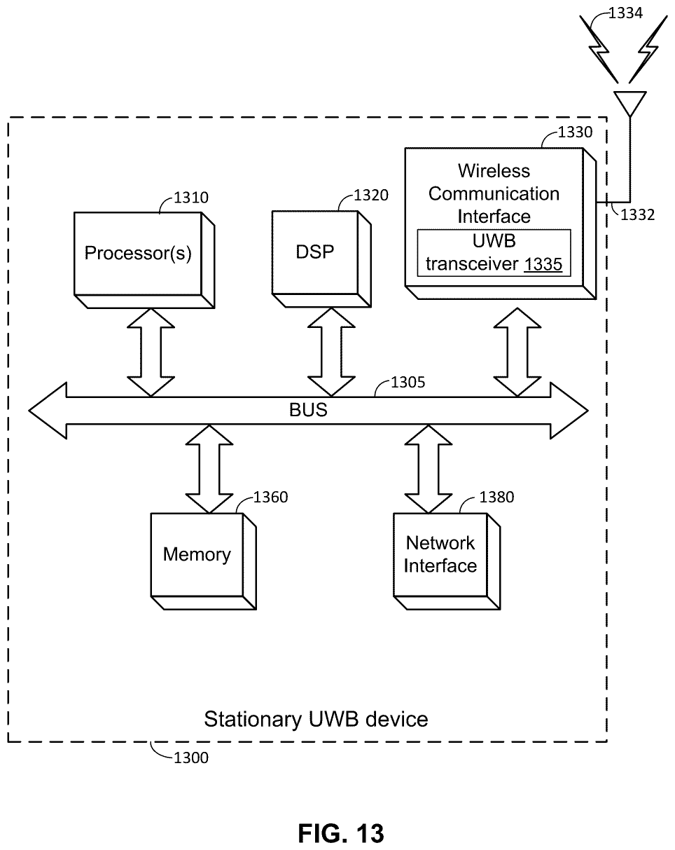

FIG. 11B is a flow diagram of a method 1100-B for cellular/UWB positioning, according to an embodiment. Means for performing the functionality illustrated in one or more of the blocks shown in FIG. 11B may be performed by hardware and/or software components of a UWB device. Example components of UWB devices are illustrated in FIGS. 12 and 13 which are described in more detail below.

At block 1150, the functionality comprises receiving, at the first wireless device, a request from a server for capability information, wherein the first wireless device is capable of transmitting both cellular and UWB wireless signals. As noted, according to some embodiments, the exchange between the server and the first wireless device may be similar to an exchange between a controller and controlee in a control phase of a UWB positioning session. As such, the server may be acting as the controller, and the first wireless device may be acting as the controlee. Communications between the server and first wireless device may be relayed by one or more additional devices (e.g., a base station of a cellular wireless network, such as an LTE or NR network, for example). Means for performing functionality at block 1150 may comprise a bus 1205, processor(s) 1210, memory 1260, wireless communication interface 1230 (including optional UWB transceiver 1235), and/or other components of a mobile UWB device 1200 as illustrated in FIG. 12 and described hereafter. Means for performing functionality at block 1150 alternatively may comprise a bus 1305, processor(s) 1310, memory 1360, wireless communication interface 1330 (including optional UWB transceiver 1335), and/or other components of a stationary UWB device 1300 as illustrated in FIG. 13 and described hereafter.

The functionality at block 1160 comprises sending, to the server, a response from the first wireless device, the response comprising the capability information including information regarding a capability of the first wireless device for performing UWB positioning. The capability information (comprising information regarding a capability of the first wireless device for performing UWB positioning) may include capability information including channel capability, measurement capability (types of measurements, precision/accuracy, etc.), timing capability (e.g., availability for UWB positioning), message format capability, and/or the like. As also noted, a device may also provide QoS-related parameters for s UWB positioning session. As such, according to some embodiments of the method 1200-B, the response received at block 1160 may further comprise QoS parameters comprising information indicative of a pulse shape, a desired accuracy, or a type of positioning algorithm for the first set of one or more UWB positioning sessions, or a combination thereof. Means for performing functionality at block 1160 may comprise a bus 1205, processor(s) 1210, memory 1260, wireless communication interface 1230 (including optional UWB transceiver 1235), and/or other components of a mobile UWB device 1200 as illustrated in FIG. 12 and described hereafter. Means for performing functionality at block 1160 alternatively may comprise a bus 1305, processor(s) 1310, memory 1360, wireless communication interface 1330 (including optional UWB transceiver 1335), and/or other components of a stationary UWB device 1300 as illustrated in FIG. 13 and described hereafter.

The functionality at block 1170 comprises receiving, at the first wireless device, first UWB assistance data from the server, wherein the first UWB assistance data comprises one or more parameters for a first set of one or more UWB positioning sessions between the first wireless device and a second wireless device. As noted, the server may comprise a location server (e.g., LMF server) that may have knowledge of where PRS will be transmitted in the cellular wireless system and used by one or more devices participating in the first set of one or more UWB positioning sessions. As such, the server may determine first UWB assistance data that aligns the UWB positioning measurements in time with PRS (e.g., in the manner indicated in the previously-described embodiments). The one or more parameters of the first set of one or more UWB positioning sessions may include a configuration that conveys this time-domain alignment. According to some embodiments, the one or more parameters for the first set of one or more UWB positioning sessions comprise a start time for a ranging block, a round of a ranging block to use, a number of slots to use within a round of a ranging block, or a frequency channel to use, or a combination thereof. Additionally or alternatively, as previously described, a server may determine a hopping pattern or use in the set of one or more UWB positioning sessions to avoid interference with PRS. As such, for some embodiments of the method 1100-B, the one or more parameters for the first set of one or more UWB positioning sessions comprise the determined hopping pattern. Means for performing functionality at block 1170 may comprise a bus 1205, processor(s) 1210, memory 1260, wireless communication interface 1230 (including optional UWB transceiver 1235), and/or other components of a mobile UWB device 1200 as illustrated in FIG. 12 and described hereafter. Means for performing functionality at block 1170 alternatively may comprise a bus 1305, processor(s) 1310, memory 1360, wireless communication interface 1330 (including optional UWB transceiver 1335), and/or other components of a stationary UWB device 1300 as illustrated in FIG. 13 and described hereafter.

At block 1180, the method 1100-B comprises conducting, using the first wireless device: the first set of one or more UWB positioning sessions with the second wireless device in accordance with the one or more parameters, and one or more measurements of one or more positioning signals transmitted in a cellular wireless network. As noted, according to some embodiments, the cellular wireless network comprises an NR wireless network and the server may comprise an LMF of the cellular wireless network. In such embodiments, the request, the response, or the first UWB assistance data, or a combination thereof, may be communicated via LPP. Additionally or alternatively, the one or more positioning signals may comprise one or more positioning reference signal PRS instances. That said, other types of signals used for positioning may be used, such as a tracking reference signal (TRS), Channel-State Information Reference Signal (CSI-RS), or others. Means for performing functionality at block 1180 may comprise a bus 1205, processor(s) 1210, memory 1260, wireless communication interface 1230 (including optional UWB transceiver 1235), and/or other components of a mobile UWB device 1200 as illustrated in FIG. 12 and described hereafter. Means for performing functionality at block 1180 alternatively may comprise a bus 1305, processor(s) 1310, memory 1360, wireless communication interface 1330 (including optional UWB transceiver 1335), and/or other components of a stationary UWB device 1300 as illustrated in FIG. 13 and described hereafter.

FIG. 12 is a block diagram of an embodiment of a mobile UWB device 1200, which can be utilized as described herein. The mobile UWB device 1200 may have cellular (e.g., 5G NR) capabilities and may therefore function as a UE in an cellular wireless network and/or perform cellular/UWB positioning as described herein. It should be noted that FIG. 12 is meant only to provide a generalized illustration of various components, any or all of which may be utilized as appropriate. For example, more basic/simple types of UWB devices may omit various components that may be included in more advanced/complex UWB devices. Furthermore, as previously noted, the functionality of the UE discussed in the previously described embodiments may be executed by one or more of the hardware and/or software components illustrated in FIG. 12.

The mobile UWB device 1200 is shown comprising hardware elements that can be electrically coupled via a bus 1205 (or may otherwise be in communication, as appropriate). The hardware elements may include processor(s) 1210 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1210 may comprise one or more processing units, which may be housed in a single integrated circuit (IC) or multiple ICs. As shown in FIG. 12, some embodiments may have a separate DSP 1220, depending on desired functionality. Location determination and/or other determinations based on wireless communication may be provided in the processor(s) 1210 and/or wireless communication interface 1230 (discussed below). The mobile UWB device 1200 also can include one or more input devices 1270, which can include without limitation one or more keyboards, touch screens, touch pads, microphones, buttons, dials, switches, and/or the like; and one or more output devices 1215, which can include without limitation one or more displays (e.g., touch screens), light emitting diodes (LEDs), speakers, and/or the like.

The mobile UWB device 1200 may also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the mobile UWB device 1200 to communicate with other devices as described herein. The wireless communication interface 1230 may permit data and signaling to be communicated (e.g., transmitted and received) with access points, various base stations and/or other access node types, and/or other network components, computer systems, and/or any other electronic devices communicatively coupled therewith. The communication can be carried out via one or more wireless communication antenna(s) 1232 that send and/or receive wireless signals 1234. According to some embodiments, the wireless communication antenna(s) 1232 may comprise a plurality of discrete antennas, antenna arrays, or any combination thereof. The antenna(s) 1232 may be capable of transmitting and receiving wireless signals using beams (e.g., Tx beams and Rx beams). Beam formation may be performed using digital and/or analog beam formation techniques, with respective digital and/or analog circuitry. The wireless communication interface 1230 may include such circuitry.

As illustrated, the wireless indication interface 1230 may further comprise a UWB transceiver 1235. The UWB transceiver 1235 may be operated to perform the UWB operations described herein. Further, the wireless communications interface 1230 may comprise one or more additional communication technologies with which any OOB functionalities described herein may be performed. According to some embodiments, the UWB transceiver 1235 may be one of a plurality of UWB transceivers of the mobile UWB device 1200. Further, the UWB transceiver may be used for functionality in addition to the UWB positioning functionality described herein. Although illustrated as part of the wireless communication interface 1230, the UWB transceiver 1235 may be separate from the wireless communication interface 1230 in some embodiments.

Depending on desired functionality, the wireless communication interface 1230 may comprise a separate receiver and transmitter, or any combination of transceivers, transmitters, and/or receivers to communicate with base stations (e.g., ng-eNBs and gNBs) and other terrestrial transceivers, such as wireless devices and access points. The mobile UWB device 1200 may communicate with different data networks that may comprise various network types. For example, a WWAN may be a CDMA network, a TDMA network, a FDMA network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A WLAN may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The mobile UWB device 1200 can further include sensor(s) 1240. Sensor(s) 1240 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the mobile UWB device 1200 may also include a GNSS receiver 1280 capable of receiving signals 1284 from one or more GNSS satellites using an antenna 1282 (which could be the same as antenna 1232). Positioning based on GNSS signal measurement can be utilized to complement and/or incorporate the techniques described herein. The GNSS receiver 1280 can extract a position of the mobile UWB device 1200, using conventional techniques, from GNSS satellites of a GNSS system, such as GPS, Galileo, GLONASS, Quasi-Zenith Satellite System (QZSS) over Japan, IRNSS over India, BeiDou Navigation Satellite System (BDS) over China, and/or the like. Moreover, the GNSS receiver 1280 can be used with various+storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1260 of the mobile UWB device 1200 also can comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the mobile UWB device 1200 (and/or processor(s) 1210 or DSP 1220 within mobile UWB device 1200). In some embodiments, then, such code and/or instructions can be used to configure and/or adapt a general-purpose computer (or other device) to perform one or more operations in accordance with the described methods.

FIG. 13 is a block diagram of an embodiment of a stationary UWB device 1300, which can be utilized as described herein. The stationary UWB device 1300 may, for example, function as a UWB anchor for UWB and/or hybrid cellular/UWB positioning of a mobile UWB device (e.g., mobile UWB device 1200). It should be noted that FIG. 13 is meant only to provide a generalized illustration of various components, any or all of which may be utilized as appropriate. In some embodiments, the stationary UWB device 1300 may correspond to an anchor UWB having a known location, which may be used to determine the location of other UWB devices, including mobile UWB devices. According to some embodiments, the stationary UWB device 1300 may be permanently stationary or temporarily stationary.

The stationary UWB device 1300 is shown comprising hardware elements that can be electrically coupled via a bus 1305 (or may otherwise be in communication, as appropriate). The hardware elements may include a processor(s) 1310 which can include without limitation one or more general-purpose processors, one or more special-purpose processors (such as DSP chips, graphics acceleration processors, ASICs, and/or the like), and/or other processing structure or means. As shown in FIG. 13, some embodiments may have a separate DSP 1320, depending on desired functionality. Location determination and/or other determinations based on wireless communication may be provided in the processor(s) 1310 and/or wireless communication interface 1330 (discussed below), according to some embodiments. The stationary UWB device 1300 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The stationary UWB device 1300 might also include a wireless communication interface 1330, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the stationary UWB device 1300 to communicate as described herein. The wireless communication interface 1330 may permit data and signaling to be communicated (e.g., transmitted and received) to mobile devices, wireless network nodes (e.g., base stations, access points, etc.), and/or other network components, computer systems, and/or any other electronic devices described herein. The communication can be carried out via one or more wireless communication antenna(s) 1332 that send and/or receive wireless signals 1334.

As illustrated, the wireless indication interface 1330 may further comprise a UWB transceiver 1335. The UWB transceiver 1335 may be operated to perform the UWB operations described herein. Further, the wireless communications interface 1330 may comprise one or more additional communication technologies with which any OOB functionalities described herein may be performed. According to some embodiments, the UWB transceiver 1335 may be one of a plurality of UWB transceivers of the mobile UWB device 1300. Further, the UWB transceiver may be used for functionality in addition to the UWB positioning functionality described herein. Although illustrated as part of the wireless communication interface 1330, the UWB transceiver 1335 may be separate from the wireless communication interface 1330 in some embodiments.

The stationary UWB device 1300 may also include a network interface 1380, which can include support of wireline communication technologies. The network interface 1380 may include a modem, network card, chipset, and/or the like. The network interface 1380 may include one or more input and/or output communication interfaces to permit data to be exchanged with a network, communication network servers, computer systems, and/or any other electronic devices described herein. In some embodiments, the stationary UWB device 1300 may be communicatively coupled with one or more servers and/or other stationary UWB devices via the network interface 1380.

In many embodiments, the stationary UWB device 1300 may further comprise a memory 1360. The memory 1360 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1360 of the stationary UWB device 1300 also may comprise software elements (not shown in FIG. 13), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1360 that are executable by the stationary UWB device 1300 (and/or processor(s) 1310 or DSP 1320 within stationary UWB device 1300). In some embodiments, then, such code and/or instructions can be used to configure and/or adapt a general-purpose computer (or other device) to perform one or more operations in accordance with the described methods.

FIG. 14 is a block diagram of an embodiment of a computer system 1400, which may be used, in whole or in part, to provide the functions of a server as described in the embodiments herein (e.g., a location server and/or LMF). It should be noted that FIG. 14 is meant only to provide a generalized illustration of various components, any or all of which may be utilized as appropriate. FIG. 14, therefore, broadly illustrates how individual system elements may be implemented in a relatively separated or relatively more integrated manner. In addition, it can be noted that components illustrated by FIG. 14 can be localized to a single device and/or distributed among various networked devices, which may be disposed at different geographical locations.

The computer system 1400 is shown comprising hardware elements that can be electrically coupled via a bus 1405 (or may otherwise be in communication, as appropriate). The hardware elements may include processor(s) 1410, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1400 also may comprise one or more input devices 1415, which may comprise without limitation a mouse, a keyboard, a camera, a microphone, and/or the like; and one or more output devices 1420, which may comprise without limitation a display device, a printer, and/or the like.

The computer system 1400 may further include (and/or be in communication with) one or more non-transitory storage devices 1425, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1400 may also include a communications subsystem 1430, which may (optionally, as indicated by dotted lines) comprise wireless communication technologies managed and controlled by a wireless communication interface 1433, as well as wired technologies (such as Ethernet, coaxial communications, universal serial bus (USB), and the like). The wireless communication interface 1433 may comprise one or more wireless transceivers that may send and receive wireless signals 1455 (e.g., signals according to 5G NR or LTE) via wireless antenna(s) 1450. Optionally, these one or more wireless transceivers may comprise a UWB transceiver 1434. Thus the communications subsystem 1430 may comprise a modem, a network card (wireless or wired), an infrared communication device, a wireless communication device, and/or a chipset, and/or the like, which may enable the computer system 1400 to communicate on any or all of the communication networks described herein to any device on the respective network. Hence, the communications subsystem 1430 may be used to receive and send data as described in the embodiments herein.

In many embodiments, the computer system 1400 will further comprise a working memory 1435, which may comprise a RAM or ROM device, as described above. Software elements, shown as being located within the working memory 1435, may comprise an operating system 1440, device drivers, executable libraries, and/or other code, such as one or more applications 1445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1425 described above. In some cases, the storage medium might be incorporated within a computer system, such as computer system 1400. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1400 and/or might take the form of source and/or installable code, which, upon compilation and/or installation on the computer system 1400 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method for cellular/ultra-wideband (UWB) positioning, the method comprising: sending a request from a server to the first wireless device for capability information, wherein a first wireless device is capable of transmitting both cellular and UWB wireless signals; receiving, at the server, a response from the first wireless device, the response comprising the capability information, wherein the capability information comprises information regarding a capability of the first wireless device for performing UWB positioning; determining first UWB assistance data for the first wireless device based at least in part on (i) the capability information and (ii) information regarding one or more positioning signals transmitted in a cellular wireless network, wherein the first UWB assistance data comprises one or more parameters for a first set of one or more UWB positioning sessions between the first wireless device and a second wireless device; and sending the first UWB assistance data from the server to the first wireless device.
Clause 2. The method of clause 1, wherein the one or more parameters for the first set of one or more UWB positioning sessions comprise: a start time for a ranging block, a round of a ranging block to use, a number of slots to use within a round of a ranging block, or a frequency channel to use, or a combination thereof.
Clause 3. The method of any of clauses 1-2 further comprising determining a hopping pattern for round usage in the first set of one or more UWB positioning sessions based on the information regarding one or more positioning signals transmitted in a cellular wireless network, wherein the one or more parameters for the first set of one or more UWB positioning sessions comprise the determined hopping pattern.
Clause 4. The method of any of clauses 1-3 wherein the one or more parameters for the first set of one or more UWB positioning sessions specify using a round selected from of a plurality of rounds of a ranging block, and wherein, for a particular positioning signal of the one or more positioning signals: the selected round is closest in time, of the plurality of rounds, to the particular positioning signal, and the selected round does not overlap in time with the particular positioning signal.
Clause 5. The method of any of clauses 1-4 further comprising sending second UWB assistance data comprising one or more parameters for a second set of one or more UWB positioning sessions, wherein the second UWB assistance data is sent from the server to the first wireless device, the second wireless device, or a third wireless device, or a combination thereof.
Clause 6. The method of clause 5 wherein the one or more parameters for the first set of one or more UWB positioning sessions specify using a first round of a first ranging block having a first round index; the one or more parameters for the second set of one or more UWB positioning sessions specify using a second round of a second ranging block having a second round index different than the first round index; and the first ranging block and the second ranging block overlap in time.
Clause 7. The method of clause 6 wherein, for a particular positioning signal closest in time, of the one or more positioning signals, to the first round the first round occurs subsequent to the particular positioning signal; and the second round occurs subsequent to the first round.
Clause 8. The method of clause 6 wherein, for a particular positioning signal closest in time, of the one or more positioning signals, to the first round the first ranging block and the second ranging block overlap in time with the particular positioning signal; the first round occurs prior to the particular positioning signal; and the second round occurs subsequent to the particular positioning signal.
Clause 9. The method of clause 5 wherein the one or more parameters for the first set of one or more UWB positioning sessions specify using a first round of a first ranging block having a first round index; the one or more parameters for the second set of one or more UWB positioning sessions specify using a second round of a second ranging block having a second round index; and the first ranging block and the second ranging block do not overlap in time.
Clause 10. The method of clause 9 wherein, for a particular positioning signal closest in time, of the one or more positioning signals, to the first ranging block the first ranging block occurs subsequent to the particular positioning signal; the second ranging block occurs subsequent to the first round; and the second round index is the same as the first round index.
Clause 11. The method of clause 10 wherein, for a particular positioning signal closest in time, of the one or more positioning signals, to the first ranging block the first ranging block occurs prior to the particular positioning signal; and the second ranging block occurs subsequent to the particular positioning signal.
Clause 12. The method of any of clauses 1-11 wherein the response further comprises Quality of Service (QOS) parameters comprising information indicative of: a pulse shape, a desired accuracy, or a type of positioning algorithm for the first set of one or more UWB positioning sessions, or a combination thereof.
Clause 13. The method of any of clauses 1-12 wherein cellular wireless network comprises a new radio (NR) wireless network and the server comprises a location management function (LMF) of the NR wireless network.
Clause 14. The method of any of clauses 1-13 wherein the request, the response, or the first UWB assistance data, or a combination thereof, are communicated via long-term evolution (LTE) positioning protocol (LPP).
Clause 15. The method of any of clauses 1-14 one or more positioning signals comprise one or more positioning reference signal (PRS) instances.
Clause 16. A server for cellular/ultra-wideband (UWB) positioning, the server comprising: a transceiver; a memory; and one or more processors communicatively coupled with the transceiver and the memory, wherein the one or more processors are configured to: send a request, via the transceiver, from the server to a first wireless device for capability information, wherein: the first wireless device is capable of transmitting both cellular and UWB wireless signals, and the capability information comprises information regarding a capability of the first wireless device for performing UWB positioning; receive, via the transceiver, a response from the first wireless device, the response comprising the capability information; determine first UWB assistance data for the first wireless device based at least in part on (i) the capability information and (ii) information regarding one or more positioning signals transmitted in a cellular wireless network, wherein the first UWB assistance data comprises one or more parameters for a first set of one or more UWB positioning sessions between the first wireless device and a second wireless device; and send the first UWB assistance data from the server to the first wireless device via the transceiver.
Clause 17. The server of clause 16, wherein the one or more processors are configured to include, in the one or more parameters for the first set of one or more UWB positioning sessions: a start time for a ranging block, a round of a ranging block to use, a number of slots to use within a round of a ranging block, or a frequency channel to use, or a combination thereof.
Clause 18. The server of any of clauses 16-17 wherein the one or more processors are further configured to determine a hopping pattern for round usage in the first set of one or more UWB positioning sessions based on the information regarding one or more positioning signals transmitted in a cellular wireless network, and wherein the one or more processors are configured to include, in the one or more parameters for the first set of one or more UWB positioning sessions, the determined hopping pattern.
Clause 19. The server of any of clauses 16-18 wherein the one or more processors are configured to include, in the one or more parameters for the first set of one or more UWB positioning sessions, a selected round to use, wherein the selected round is selected from of a plurality of rounds of a ranging block, and wherein, for a particular positioning signal of the one or more positioning signals: the selected round is closest in time, of the plurality of rounds, to the particular positioning signal, and the selected round does not overlap in time with the particular positioning signal.
Clause 20. The server of any of clauses 16-19 wherein the one or more processors are further configured to send second UWB assistance data comprising one or more parameters for a second set of one or more UWB positioning sessions, wherein the one or more processors are configured to send the second UWB assistance data via the transceiver to the first wireless device, the second wireless device, or a third wireless device, or a combination thereof.
Clause 21. The server of clause 20 wherein the one or more processors are configured to determine the one or more parameters such that: the one or more parameters for the first set of one or more UWB positioning sessions specify using a first round of a first ranging block having a first round index; the one or more parameters for the second set of one or more UWB positioning sessions specify using a second round of a second ranging block having a second round index different than the first round index; and the first ranging block and the second ranging block overlap in time.
Clause 22. The server of clause 21 wherein the one or more processors are configured to further determine the one or more parameters such that, for a particular positioning signal closest in time, of the one or more positioning signals, to the first round: the first round occurs subsequent to the particular positioning signal; and the second round occurs subsequent to the first round.
Clause 23. The server of any of clause 21 wherein the one or more processors are configured to further determine the one or more parameters such that, for a particular positioning signal closest in time, of the one or more positioning signals, to the first round: the first ranging block and the second ranging block overlap in time with the particular positioning signal; the first round occurs prior to the particular positioning signal; and the second round occurs subsequent to the particular positioning signal.
Clause 24. The server of clause 20 wherein the one or more processors are configured to determine the one or more parameters such that: the one or more parameters for the first set of one or more UWB positioning sessions specify using a first round of a first ranging block having a first round index; the one or more parameters for the second set of one or more UWB positioning sessions specify using a second round of a second ranging block having a second round index; and the first ranging block and the second ranging block do not overlap in time.
Clause 25. The server of clause 24 wherein the one or more processors are configured to further determine the one or more parameters such that, for a particular positioning signal closest in time, of the one or more positioning signals, to the first ranging block: the first ranging block occurs subsequent to the particular positioning signal; the second ranging block occurs subsequent to the first round; and the second round index is the same as the first round index.
Clause 26. The server of clause 24 wherein the one or more processors are configured to further determine the one or more parameters such that, for a particular positioning signal closest in time, of the one or more positioning signals, to the first ranging block: the first ranging block occurs prior to the particular positioning signal; and the second ranging block occurs subsequent to the particular positioning signal.
Clause 27. The server of any of clauses 16-26 wherein, to receive the response, the one or more processors are configured to receive Quality of Service (QOS) parameters comprising information indicative of a pulse shape, a desired accuracy, or a type of positioning algorithm for the first set of one or more UWB positioning sessions, or a combination thereof.
Clause 28. The server of any of clauses 16-27 wherein cellular wireless network comprises a new radio (NR) wireless network and the server comprises a location management function (LMF) of the NR wireless network.
Clause 29. A method of for cellular/ultra-wideband (UWB) positioning, the method comprising: receiving, at a first wireless device, a request from a server for capability information, wherein the first wireless device is capable of transmitting both cellular and UWB wireless signals; sending, to the server, a response from the first wireless device, the response comprising the capability information including information regarding a capability of the first wireless device for performing UWB positioning; receiving, at the first wireless device, first UWB assistance data from the server, wherein the first UWB assistance data comprises one or more parameters for a first set of one or more UWB positioning sessions between the first wireless device and a second wireless device; and conducting, using the first wireless device: the first set of one or more UWB positioning sessions with the second wireless device in accordance with the one or more parameters, and one or more measurements of one or more positioning signals transmitted in a cellular wireless network.
Clause 30. The method of clause 29, wherein the one or more parameters for the first set of one or more UWB positioning sessions comprise: a start time for a ranging block, a round of a ranging block to use, a number of slots to use within a round of a ranging block, or a frequency channel to use, or a combination thereof.
Clause 31. The method of any of clauses 29-30, wherein the one or more parameters for the first set of one or more UWB positioning sessions comprise a hopping pattern.
Clause 32. The method of any of clauses 29-31, wherein the one or more parameters for the first set of one or more UWB positioning sessions specify using a round selected from of a plurality of rounds of a ranging block, and wherein, for a particular positioning signal of the one or more positioning signals: the selected round is closest in time, of the plurality of rounds, to the particular positioning signal, and the selected round does not overlap in time with the particular positioning signal.
Clause 33. The method of any of clauses 29-32, further comprising receiving, at the first wireless device, second UWB assistance data comprising one or more parameters for a second set of one or more UWB positioning sessions, wherein the second UWB assistance data is sent from the server.
Clause 34. The method of clause 33, wherein: the one or more parameters for the first set of one or more UWB positioning sessions specify using a first round of a first ranging block having a first round index; the one or more parameters for the second set of one or more UWB positioning sessions specify using a second round of a second ranging block having a second round index different than the first round index; and the first ranging block and the second ranging block overlap in time.
Clause 35. The method of clause 34, wherein, for a particular positioning signal closest in time, of the one or more positioning signals, to the first round: the first round occurs subsequent to the particular positioning signal; and the second round occurs subsequent to the first round.
Clause 36. The method of clause 34, wherein, for a particular positioning signal closest in time, of the one or more positioning signals, to the first round: the first ranging block and the second ranging block overlap in time with the particular positioning signal; the first round occurs prior to the particular positioning signal; and the second round occurs subsequent to the particular positioning signal.
Clause 37. The method of clause 33, wherein: the one or more parameters for the first set of one or more UWB positioning sessions specify using a first round of a first ranging block having a first round index; the one or more parameters for the second set of one or more UWB positioning sessions specify using a second round of a second ranging block having a second round index; and the first ranging block and the second ranging block do not overlap in time.
Clause 38. The method of clause 37, wherein, for a particular positioning signal closest in time, of the one or more positioning signals, to the first ranging block: the first ranging block occurs subsequent to the particular positioning signal; the second ranging block occurs subsequent to the first round; and the second round index is the same as the first round index.
Clause 39. The method of clause 37, wherein, for a particular positioning signal closest in time, of the one or more positioning signals, to the first ranging block: the first ranging block occurs prior to the particular positioning signal; and the second ranging block occurs subsequent to the particular positioning signal.
Clause 40. The method of any of clauses 29-39, further comprising including, in the response, Quality of Service (QOS) parameters comprising information indicative of: a pulse shape, a desired accuracy, or a type of positioning algorithm for the first set of one or more UWB positioning sessions, or a combination thereof.
Clause 41. The method of any of clauses 29-40, wherein cellular wireless network comprises a new radio (NR) wireless network and the server comprises a location management function (LMF) of the NR wireless network.
Clause 42. The method of any of clauses 29-41, wherein the request, the response, or the first UWB assistance data, or a combination thereof, are communicated via long-term evolution (LTE) positioning protocol (LPP).
Clause 43. The method of any of clauses 29-42, one or more positioning signals comprise one or more positioning reference signal (PRS) instances.
Clause 44. A first wireless device for cellular/ultra-wideband (UWB) positioning, the first wireless device comprising: one or more transceivers capable of transmitting both cellular and UWB wireless signals; a memory; and one or more processors communicatively coupled with the one or more transceivers and the memory, wherein the one or more processors are configured to: receive, via the one or more transceivers, a request from a server for capability information; send a response via the one or more transceivers to the server, the response comprising the capability information including information regarding a capability of the first wireless device for performing UWB positioning; receive, via the one or more transceivers, first UWB assistance data from the server, wherein the first UWB assistance data comprises one or more parameters for a first set of one or more UWB positioning sessions between the first wireless device and a second wireless device; and conduct: the first set of one or more UWB positioning sessions with the second wireless device in accordance with the one or more parameters, and one or more measurements of one or more positioning signals transmitted in a cellular wireless network.
Clause 45. The first wireless device of clause 44, wherein the one or more processors are configured to receive, in the one or more parameters for the first set of one or more UWB positioning sessions: a start time for a ranging block, a round of a ranging block to use, a number of slots to use within a round of a ranging block, or a frequency channel to use, or a combination thereof.
Clause 46. The first wireless device of any of clauses 44-45, wherein the one or more processors are configured to receive, in the one or more parameters for the first set of one or more UWB positioning sessions, a hopping pattern.
Clause 47. The first wireless device of any of clauses 44-46, wherein the one or more processors are configured to receive, in the one or more parameters for the first set of one or more UWB positioning sessions, a selected round to use, wherein the selected round is selected from of a plurality of rounds of a ranging block, and wherein, for a particular positioning signal of the one or more positioning signals: the selected round is closest in time, of the plurality of rounds, to the particular positioning signal, and the selected round does not overlap in time with the particular positioning signal.
Clause 48. The first wireless device any of clauses 44-47, wherein the one or more processors are further configured to receive second UWB assistance data comprising one or more parameters for a second set of one or more UWB positioning sessions wherein the second UWB assistance data is sent from the server.
Clause 49. The first wireless device of clause 48, wherein, to perform the first set of one or more UWB positioning sessions and the second set of one or more UWB positioning sessions, the one or more processors are configured to: use a first round of a first ranging block having a first round index; and use a second round of a second ranging block having a second round index different than the first round index, wherein the first ranging block and the second ranging block overlap in time.
Clause 50. The first wireless device of clause 49, wherein, to perform the first set of one or more UWB positioning sessions and the second set of one or more UWB positioning sessions, the one or more processors are configured to operate such that, for a particular positioning signal closest in time, of the one or more positioning signals, to the first round: the first round occurs subsequent to the particular positioning signal; and the second round occurs subsequent to the first round.
Clause 51. The first wireless device of clause 49, wherein, to perform the first set of one or more UWB positioning sessions and the second set of one or more UWB positioning sessions, the one or more processors are configured to operate such that, for a particular positioning signal closest in time, of the one or more positioning signals, to the first round: the first ranging block and the second ranging block overlap in time with the particular positioning signal; the first round occurs prior to the particular positioning signal; and the second round occurs subsequent to the particular positioning signal.
Clause 52. The first wireless device of clause 48, wherein, to perform the first set of one or more UWB positioning sessions and the second set of one or more UWB positioning sessions, the one or more processors are configured to: use a first round of a first ranging block having a first round index; and use a second round of a second ranging block having a second round index; wherein the first ranging block and the second ranging block do not overlap in time.
Clause 53. The first wireless device of clause 52, wherein, to perform the first set of one or more UWB positioning sessions and the second set of one or more UWB positioning sessions, the one or more processors are configured to operate such that, for a particular positioning signal closest in time, of the one or more positioning signals, to the first ranging block: the first ranging block occurs subsequent to the particular positioning signal; the second ranging block occurs subsequent to the first round; and the second round index is the same as the first round index.
Clause 54. The first wireless device of clause 52, wherein, to perform the first set of one or more UWB positioning sessions and the second set of one or more UWB positioning sessions, the one or more processors are configured to operate such that, for a particular positioning signal closest in time, of the one or more positioning signals, to the first ranging block: the first ranging block occurs prior to the particular positioning signal; and the second ranging block occurs subsequent to the particular positioning signal.
Clause 55. The first wireless device of any of clauses 44-54, wherein the one or more processors are configured to include, in the response, Quality of Service (QOS) parameters comprising information indicative of: a pulse shape, a desired accuracy, or a type of positioning algorithm for the first set of one or more UWB positioning sessions, or a combination thereof.
Clause 56. The first wireless device of any of clauses 44-55, wherein cellular wireless network comprises a new radio (NR) wireless network and the server comprises a location management function (LMF) of the NR wireless network.

What is claimed is:

1. A method for cellular/ultra-wideband (UWB) positioning, the method comprising:
sending a request from a server to a first wireless device for capability information, wherein the first wireless device is capable of transmitting both cellular and UWB wireless signals;
receiving, at the server, a response from the first wireless device, the response comprising the capability information including information regarding a capability of the first wireless device for performing UWB positioning;
determining first UWB assistance data for the first wireless device based at least in part on (i) the capability information and (ii) information regarding one or more positioning signals transmitted in a cellular wireless network, wherein the first UWB assistance data comprises one or more parameters for a first set of one or more UWB positioning sessions between the first wireless device and a second wireless device; and
sending the first UWB assistance data from the server to the first wireless device.

2. The method of claim 1, wherein the one or more parameters for the first set of one or more UWB positioning sessions comprise:
a start time for a ranging block,
a round of a ranging block to use,
a number of slots to use within a round of a ranging block, or
a frequency channel to use, or
a combination thereof.

3. The method of claim 1, further comprising determining a hopping pattern for round usage in the first set of one or more UWB positioning sessions based on the information regarding one or more positioning signals transmitted in a cellular wireless network, wherein the one or more parameters for the first set of one or more UWB positioning sessions comprise the determined hopping pattern.

4. The method of claim 1, wherein the one or more parameters for the first set of one or more UWB positioning sessions specify using a round selected from of a plurality of rounds of a ranging block, and wherein, for a particular positioning signal of the one or more positioning signals:
the selected round is closest in time, of the plurality of rounds, to the particular positioning signal, and
the selected round does not overlap in time with the particular positioning signal.

5. The method of claim 1, further comprising sending second UWB assistance data comprising one or more parameters for a second set of one or more UWB positioning sessions, wherein the second UWB assistance data is sent from the server to the first wireless device, the second wireless device, or a third wireless device, or a combination thereof.

6. The method of claim 5, wherein:
the one or more parameters for the first set of one or more UWB positioning sessions specify using a first round of a first ranging block having a first round index;
the one or more parameters for the second set of one or more UWB positioning sessions specify using a second round of a second ranging block having a second round index different than the first round index; and
the first ranging block and the second ranging block overlap in time.

7. The method of claim 6, wherein, for a particular positioning signal closest in time, of the one or more positioning signals, to the first round:
the first round occurs subsequent to the particular positioning signal; and
the second round occurs subsequent to the first round.

8. The method of claim 6, wherein, for a particular positioning signal closest in time, of the one or more positioning signals, to the first round:
the first ranging block and the second ranging block overlap in time with the particular positioning signal;
the first round occurs prior to the particular positioning signal; and
the second round occurs subsequent to the particular positioning signal.

9. The method of claim 5, wherein:
the one or more parameters for the first set of one or more UWB positioning sessions specify using a first round of a first ranging block having a first round index;
the one or more parameters for the second set of one or more UWB positioning sessions specify using a second round of a second ranging block having a second round index; and
the first ranging block and the second ranging block do not overlap in time.

10. The method of claim 9, wherein, for a particular positioning signal closest in time, of the one or more positioning signals, to the first ranging block:
the first ranging block occurs subsequent to the particular positioning signal;
the second ranging block occurs subsequent to the first round; and
the second round index is the same as the first round index.

11. The method of claim 9, wherein, for a particular positioning signal closest in time, of the one or more positioning signals, to the first ranging block:
the first ranging block occurs prior to the particular positioning signal; and
the second ranging block occurs subsequent to the particular positioning signal.

12. The method of claim 1, wherein the response further comprises Quality of Service (QOS) parameters comprising information indicative of:
a pulse shape,
a desired accuracy, or
a type of positioning algorithm for the first set of one or more UWB positioning sessions, or
a combination thereof.

13. The method of claim 1, wherein cellular wireless network comprises a new radio (NR) wireless network and the server comprises a location management function (LMF) of the NR wireless network.

14. The method of claim 1, wherein the request, the response, or the first UWB assistance data, or a combination thereof, are communicated via long-term evolution (LTE) positioning protocol (LPP).

15. The method of claim 1, one or more positioning signals comprise one or more positioning reference signal (PRS) instances.

16. A server for cellular/ultra-wideband (UWB) positioning, the server comprising:
a transceiver;
a memory; and
one or more processors communicatively coupled with the transceiver and the memory, wherein the one or more processors are configured to:
send a request, via the transceiver, from the server to a first wireless device for capability information, wherein the first wireless device is capable of transmitting both cellular and UWB wireless signals;
receive, via the transceiver, a response from the first wireless device, the response comprising the capability information including information regarding a capability of the first wireless device for performing UWB positioning;
determine first UWB assistance data for the first wireless device based at least in part on (i) the capability information and (ii) information regarding one or more positioning signals transmitted in a cellular wireless network, wherein the first UWB assistance data comprises one or more parameters for a first set of one or more UWB positioning sessions between the first wireless device and a second wireless device; and
send the first UWB assistance data from the server to the first wireless device via the transceiver.

17. The server of claim 16, wherein the one or more processors are configured to include, in the one or more parameters for the first set of one or more UWB positioning sessions:
a start time for a ranging block,
a round of a ranging block to use,
a number of slots to use within a round of a ranging block, or
a frequency channel to use, or
a combination thereof.

18. The server of claim 16, wherein the one or more processors are further configured to determine a hopping pattern for round usage in the first set of one or more UWB positioning sessions based on the information regarding one or more positioning signals transmitted in a cellular wireless network, and wherein the one or more processors are configured to include, in the one or more parameters for the first set of one or more UWB positioning sessions, the determined hopping pattern.

19. The server of claim 16, wherein the one or more processors are configured to include, in the one or more parameters for the first set of one or more UWB positioning sessions, a selected round to use, wherein the selected round is selected from of a plurality of rounds of a ranging block, and wherein, for a particular positioning signal of the one or more positioning signals:
the selected round is closest in time, of the plurality of rounds, to the particular positioning signal, and
the selected round does not overlap in time with the particular positioning signal.

20. The server of claim 16, wherein the one or more processors are further configured to send second UWB assistance data comprising one or more parameters for a second set of one or more UWB positioning sessions, wherein the one or more processors are configured to send the second UWB assistance data via the transceiver to the first wireless device, the second wireless device, or a third wireless device, or a combination thereof.

21. The server of claim 20, wherein the one or more processors are configured to determine the one or more parameters such that:
the one or more parameters for the first set of one or more UWB positioning sessions specify using a first round of a first ranging block having a first round index;
the one or more parameters for the second set of one or more UWB positioning sessions specify using a second round of a second ranging block having a second round index different than the first round index; and
the first ranging block and the second ranging block overlap in time.

22. The server of claim 21, wherein the one or more processors are configured to further determine the one or more parameters such that, for a particular positioning signal closest in time, of the one or more positioning signals, to the first round:
the first round occurs subsequent to the particular positioning signal; and
the second round occurs subsequent to the first round.

23. The server of claim 21, wherein the one or more processors are configured to further determine the one or more parameters such that, for a particular positioning signal closest in time, of the one or more positioning signals, to the first round:
the first ranging block and the second ranging block overlap in time with the particular positioning signal;
the first round occurs prior to the particular positioning signal; and
the second round occurs subsequent to the particular positioning signal.

24. The server of claim 20, wherein the one or more processors are configured to determine the one or more parameters such that:
the one or more parameters for the first set of one or more UWB positioning sessions specify using a first round of a first ranging block having a first round index;
the one or more parameters for the second set of one or more UWB positioning sessions specify using a second round of a second ranging block having a second round index; and
the first ranging block and the second ranging block do not overlap in time.

25. The server of claim 24, wherein the one or more processors are configured to further determine the one or more parameters such that, for a particular positioning signal closest in time, of the one or more positioning signals, to the first ranging block:
the first ranging block occurs subsequent to the particular positioning signal;
the second ranging block occurs subsequent to the first round; and
the second round index is the same as the first round index.

26. The server of claim 24, wherein the one or more processors are configured to further determine the one or more parameters such that, for a particular positioning signal closest in time, of the one or more positioning signals, to the first ranging block:
the first ranging block occurs prior to the particular positioning signal; and
the second ranging block occurs subsequent to the particular positioning signal.

27. The server of claim 16, wherein, to receive the response, the one or more processors are configured to receive Quality of Service (QOS) parameters comprising information indicative of:
a pulse shape,
a desired accuracy, or
a type of positioning algorithm for the first set of one or more UWB positioning sessions, or
a combination thereof.

28. The server of claim 16, wherein cellular wireless network comprises a new radio (NR) wireless network and the server comprises a location management function (LMF) of the NR wireless network.

29. A method for cellular/ultra-wideband (UWB) positioning, the method comprising:
receiving, at a first wireless device, a request from a server for capability information, wherein the first wireless device is capable of transmitting both cellular and UWB wireless signals;
sending, to the server, a response from the first wireless device, the response comprising the capability information including information regarding a capability of the first wireless device for performing UWB positioning;
receiving, at the first wireless device, first UWB assistance data from the server, wherein the first UWB assistance data comprises one or more parameters for a first set of one or more UWB positioning sessions between the first wireless device and a second wireless device; and
conducting, using the first wireless device:
the first set of one or more UWB positioning sessions with the second wireless device in accordance with the one or more parameters, and
one or more measurements of one or more positioning signals transmitted in a cellular wireless network.

30. The method of claim 29, wherein the one or more parameters for the first set of one or more UWB positioning sessions comprise:
a start time for a ranging block,
a round of a ranging block to use,
a number of slots to use within a round of a ranging block, or
a frequency channel to use, or
a combination thereof.

31. The method of claim 29, wherein the one or more parameters for the first set of one or more UWB positioning sessions comprise a hopping pattern.

32. The method of claim 29, wherein the one or more parameters for the first set of one or more UWB positioning sessions specify using a round selected from of a plurality of rounds of a ranging block, and wherein, for a particular positioning signal of the one or more positioning signals:
the selected round is closest in time, of the plurality of rounds, to the particular positioning signal, and
the selected round does not overlap in time with the particular positioning signal.

33. The method of claim 29, further comprising receiving, at the first wireless device, second UWB assistance data comprising one or more parameters for a second set of one or more UWB positioning sessions, wherein the second UWB assistance data is sent from the server.

34. The method of claim 33, wherein:
the one or more parameters for the first set of one or more UWB positioning sessions specify using a first round of a first ranging block having a first round index;
the one or more parameters for the second set of one or more UWB positioning sessions specify using a second round of a second ranging block having a second round index different than the first round index; and
the first ranging block and the second ranging block overlap in time.

35. The method of claim 34, wherein, for a particular positioning signal closest in time, of the one or more positioning signals, to the first round:
the first round occurs subsequent to the particular positioning signal; and
the second round occurs subsequent to the first round.

36. The method of claim 34, wherein, for a particular positioning signal closest in time, of the one or more positioning signals, to the first round:
the first ranging block and the second ranging block overlap in time with the particular positioning signal;
the first round occurs prior to the particular positioning signal; and
the second round occurs subsequent to the particular positioning signal.

37. The method of claim 33, wherein:
the one or more parameters for the first set of one or more UWB positioning sessions specify using a first round of a first ranging block having a first round index;
the one or more parameters for the second set of one or more UWB positioning sessions specify using a second round of a second ranging block having a second round index; and
the first ranging block and the second ranging block do not overlap in time.

38. The method of claim 37, wherein, for a particular positioning signal closest in time, of the one or more positioning signals, to the first ranging block:
the first ranging block occurs subsequent to the particular positioning signal;
the second ranging block occurs subsequent to the first round; and
the second round index is the same as the first round index.

39. The method of claim 37, wherein, for a particular positioning signal closest in time, of the one or more positioning signals, to the first ranging block:
the first ranging block occurs prior to the particular positioning signal; and
the second ranging block occurs subsequent to the particular positioning signal.

40. The method of claim 29, further comprising including, in the response, Quality of Service (QOS) parameters comprising information indicative of:
a pulse shape,
a desired accuracy, or
a type of positioning algorithm for the first set of one or more UWB positioning sessions, or
a combination thereof.

41. The method of claim 29, wherein cellular wireless network comprises a new radio (NR) wireless network and the server comprises a location management function (LMF) of the NR wireless network.

42. The method of claim 29, wherein the request, the response, or the first UWB assistance data, or a combination thereof, are communicated via long-term evolution (LTE) positioning protocol (LPP).

43. The method of claim 29, one or more positioning signals comprise one or more positioning reference signal (PRS) instances.

44. A first wireless device for cellular/ultra-wideband (UWB) positioning, the first wireless device comprising:
one or more transceivers capable of transmitting both cellular and UWB wireless signals;
a memory; and
one or more processors communicatively coupled with the one or more transceivers and the memory, wherein the one or more processors are configured to:
receive, via the one or more transceivers, a request from a server for capability information;
send a response via the one or more transceivers to the server, the response comprising the capability information including information regarding a capability of the first wireless device for performing UWB positioning;
receive, via the one or more transceivers, first UWB assistance data from the server, wherein the first UWB assistance data comprises one or more parameters for a first set of one or more UWB positioning sessions between the first wireless device and a second wireless device; and
conduct:
the first set of one or more UWB positioning sessions with the second wireless device in accordance with the one or more parameters, and
one or more measurements of one or more positioning signals transmitted in a cellular wireless network.

45. The first wireless device of claim 44, wherein the one or more processors are configured to receive, in the one or more parameters for the first set of one or more UWB positioning sessions:
a start time for a ranging block,
a round of a ranging block to use,
a number of slots to use within a round of a ranging block, or
a frequency channel to use, or
a combination thereof.

46. The first wireless device of claim 44, wherein the one or more processors are configured to receive, in the one or more parameters for the first set of one or more UWB positioning sessions, a hopping pattern.

47. The first wireless device of claim 44, wherein the one or more processors are configured to receive, in the one or more parameters for the first set of one or more UWB positioning sessions, a selected round to use, wherein the selected round is selected from of a plurality of rounds of a ranging block, and wherein, for a particular positioning signal of the one or more positioning signals:
the selected round is closest in time, of the plurality of rounds, to the particular positioning signal, and
the selected round does not overlap in time with the particular positioning signal.

48. The first wireless device of claim 44, wherein the one or more processors are further configured to receive second UWB assistance data comprising one or more parameters for a second set of one or more UWB positioning sessions wherein the second UWB assistance data is sent from the server.

49. The first wireless device of claim 48, wherein, to perform the first set of one or more UWB positioning sessions and the second set of one or more UWB positioning sessions, the one or more processors are configured to:
use a first round of a first ranging block having a first round index; and
use a second round of a second ranging block having a second round index different than the first round index, wherein the first ranging block and the second ranging block overlap in time.

50. The first wireless device of claim 49, wherein, to perform the first set of one or more UWB positioning sessions and the second set of one or more UWB positioning sessions, the one or more processors are configured to operate such that, for a particular positioning signal closest in time, of the one or more positioning signals, to the first round:
the first round occurs subsequent to the particular positioning signal; and
the second round occurs subsequent to the first round.

51. The first wireless device of claim 49, wherein, to perform the first set of one or more UWB positioning sessions and the second set of one or more UWB positioning sessions, the one or more processors are configured to operate such that, for a particular positioning signal closest in time, of the one or more positioning signals, to the first round:
the first ranging block and the second ranging block overlap in time with the particular positioning signal;
the first round occurs prior to the particular positioning signal; and
the second round occurs subsequent to the particular positioning signal.

52. The first wireless device of claim 48, wherein, to perform the first set of one or more UWB positioning sessions and the second set of one or more UWB positioning sessions, the one or more processors are configured to:
use a first round of a first ranging block having a first round index; and
use a second round of a second ranging block having a second round index; wherein the first ranging block and the second ranging block do not overlap in time.

53. The first wireless device of claim 52, wherein, to perform the first set of one or more UWB positioning sessions and the second set of one or more UWB positioning sessions, the one or more processors are configured to operate such that, for a particular positioning signal closest in time, of the one or more positioning signals, to the first ranging block:
the first ranging block occurs subsequent to the particular positioning signal;
the second ranging block occurs subsequent to the first round; and
the second round index is the same as the first round index.

54. The first wireless device of claim 52, wherein, to perform the first set of one or more UWB positioning sessions and the second set of one or more UWB positioning sessions, the one or more processors are configured to operate such that, for a particular positioning signal closest in time, of the one or more positioning signals, to the first ranging block:
the first ranging block occurs prior to the particular positioning signal; and
the second ranging block occurs subsequent to the particular positioning signal.

55. The first wireless device of claim 44, wherein the one or more processors are configured to include, in the response, Quality of Service (QOS) parameters comprising information indicative of:
a pulse shape,
a desired accuracy, or
a type of positioning algorithm for the first set of one or more UWB positioning sessions, or
a combination thereof.

56. The first wireless device of claim 44, wherein cellular wireless network comprises a new radio (NR) wireless network and the server comprises a location management function (LMF) of the NR wireless network.
